(19) United States
(12) Patent Application Publication
(10) Pub. No.: US 2022/0318844 A1
(43) Pub. Date: Oct. 6, 2022

(54) SYSTEMS AND METHODS FOR MEASURING THE STRENGTH OF USER ENGAGEMENT OVER A NETWORK

(71) Applicant: Boon Road, Inc., San Carlos, CA (US)

(72) Inventors: Jon Ivanco, San Carlos, CA (US); Giancarlo Buomprisco, Castel San Lorenzo (IT)

(21) Appl. No.: 17/707,501

(22) Filed: Mar. 29, 2022

Related U.S. Application Data
(60) Provisional application No. 63/169,421, filed on Apr. 1, 2021.

(51) Int. Cl. G06Q 30/02

(52) U.S. Cl. CPC G06Q 30/0242; G06Q 30/0236

(57) ABSTRACT

Systems and methods are described herein for measuring the strength of a user engagement strategy including zero-party data over a network. Specifically, upon receiving, at a server, user data and user actions from a plurality of client devices and information from remote servers, the server aggregates the received user data and user actions, and generates an output corresponding to user engagement based on the aggregated received user data, the aggregated received user actions, and the information from remote servers.

### BACKGROUND

The present disclosure is directed to measuring user engagement with regard to advertising campaigns, in order to generate more successful advertising campaigns that more effectively drive user engagement and commerce.

### SUMMARY

The current online marketing paradigm demands a high monetary cost to convert browsing users into purchasers. Because of the high cost—and the corresponding increased risk of loss—associated with the conversion of a user to a purchaser, online marketers place undue pressure on prospective buyers for a single transaction. Because of the single-transaction focus, websites often fail to develop longtime customers and miss out on long-term revenue at a reduced cost from repeat customers. By only taking single-transaction data into account, websites also fail to accurately measure the level at which website users engage with advertising campaigns. This leads to inaccurate revenue insights and potentially less effective future marketing campaigns.

One approach to gathering more information about user engagement involves gathering information directly from the website user. Oftentimes a website includes a form to collect information about a new user. However, current website forms require the new user to complete the form in its entirety prior to storing the information about the new user. Accordingly, when the new user fails to complete the form, the website operator loses all the information entered by the new user. In such instances, when the user returns to the website, the website presents the user with the same form again and burdens the user with providing answers to the form once more. The information provided by a user in the responses to the form (e.g., data inputted into a form by a user) is valuable to the website operator. However, when the user fails to provide identifying information (e.g., an email address and/or phone number), the website operator may lose the form data once the user exits the website. The website operator then cannot link the form data to the user, even if the user returns to the website and provides identifying information at a later time.

In some instances, a website may request a significant amount of user information in a single form. For example, a form may ask for identifying information (e.g., an email address and/or phone number) from the user, a birthdate for the user, information about the user's purchase habits, etc. Upon viewing the form, the user may feel overwhelmed by the amount of information requested by the form and may exit the website without completing the form. In such instances, website operators miss the opportunity to collect any information about the user by requesting all information about the user in a single form.

In some instances, a website may implement a progressive profiling model to collect information about a new user. In such instances, when a new user accesses a website, the website prompts the new user for identifying information (e.g., an email address and/or phone number). Once the new user provides the identifying information, a server associated with the website operator creates a profile for the new user. The server sends the newly subscribed user an email to provide additional information. The subscribed user must then go to their email, open the email, click on a link within the email, access an additional form via the link, and fill out the form. Because of the cumbersome process, subscribed users oftentimes do not even open the email, let alone complete the form provided via the link in the email, leading to a significant drop-off rate. Accordingly, website operators miss out on the opportunity to collect zero-party data (i.e., information that the user affirmatively provides to the website operator, for example, responses to a form, service ticket, etc.).

Another approach to gathering more information about user engagement involves collecting first-party data (i.e., data a website operator collects from the browsing actions and activities of a user to the website through cookies), using, for example, pixel tracking, cookies, or cross-device identification (“XDID”). However, the first-party data lacks any check on the quality of the data because of the passive collection. The website operator or advertiser must therefore observe, infer, and assume facts about the customer from the collected information. Accordingly, even when website operators collect first-party data on websites, it is less valuable than any information that users affirmatively provide (e.g., zero-party data).

In some instances, the website provides a user with an incentive to complete an action. For example, the online store may provide a new user with a single-use coupon code in exchange for identifying information (e.g., an email address and/or phone number). However, once the new user provides the identifying information, the website provides the single-use coupon code to the user before collecting any additional information from the user and does not incentivize the user to provide any additional information. As discussed above, the user may be disincentivized if the form is too long and asks for additional information before providing the single-use coupon code. Accordingly, the user may use the coupon code, after providing an email address and/or phone number, to make a single purchase; however, the user may not return to the website in the future to make additional purchases.

Additionally, the coupon codes issued by website operators are all generic and the same for all users, which limits the ability of the website to accurately track the use of the coupon code. For example, when a website operator provides a coupon code to an affiliate or influencer to issue to the affiliate's or influencer's audience, the source from which a user obtained the coupon code (e.g., directly from the affiliate or influencer or from a source that leaked the coupon code) cannot be accurately tracked. Thus, an opportunity is missed to accurately identify the most influential influencers/promoters or to accurately track the source of a user using the affiliate's or influencer's coupon code, and to identify fraudulent use and distribution of the coupon codes.

In other instances, a user may provide identifying information to a website via a form at a first prompt but may provide different identifying information when performing an action on the website. For example, a new user may provide a first email address when filling out questions in a form (e.g., an email address the user uses to collect spam) but may provide a second email address when performing a check-out process (e.g., an email address the user uses as a primary email account). Current systems create a separate and distinct profile for each email address provided by the user, thereby creating two distinct and separate profiles for the same user. Accordingly, current systems fail to link form answers and the purchase in a single profile for the user.

Another approach to gathering more information about user engagement involves accessing information from data trackers. In some instances, websites transmit user information to data trackers and receive information about advertising campaigns and how users interact with the websites. However, information from data tracking platforms lacks the context of what the user does after navigating off of the webpage after selecting, or not selecting, the ad. Additionally, website operators may require multiple different trackers to capture a wide range of user interactions. Because the tracking systems lack the context of the user actions, and because website operators may require multiple trackers to capture all user interactions, it is difficult for website operators to ascertain an overall record of user engagement.

Systems and methods are described herein that address the problems outlined above by, for example, gathering zero-party data that users provide and first-party data from website user browsing actions and activities, aggregating the zero-party and first-party data, and generating an output corresponding to user engagement based on the aggregated data. In some instances, systems and methods described herein additionally aggregate data from third-party platforms prior to generating the output. A server uses the aggregated data to generate an output corresponding to user engagement. In some embodiments, website operators may use the output as a metric to measure the success of a single advertising campaign or compare the successes of different advertising campaigns. The insights from the combination of all types of data about user engagement provide a full picture from which to measure the level at which website users engage with advertising campaigns, make accurate revenue judgments, and generate more effective future marketing campaigns.

The systems and methods herein collect zero-party data about a new user of a website in a temporary profile. For example, when a new user lands on a page of a website, the website may ask the new user a series of questions in, e.g., a form. In some embodiments, the form asks for information about the user, without requesting identifying information for the user (e.g., an email address). For example, the form may request information about what size shoe the user wears but may not ask for an email address and/or phone number of the user (e.g., identifying information).

In some embodiments, a server links the information about the new user to a particular person after the collection of identifying information (e.g., once a user provides identifying information such as an email address or phone number). For example, the system may create a temporary profile for a new user when the new user visits a website for the first time and/or answers one or more prompts. For example, the system may generate a unique ID number for the user (e.g., user #123) and may store the responses to user-interactive response fields within the form in association with the unique ID number (e.g., user #123). By creating a temporary profile for the new user in the absence of identifying information, the system collects data about the user and can import data from the temporary profile into the permanent profile created for the user when the user provides the identifying information.

For example, when a new user arrives to a website, the system may generate a unique identifier for the user (e.g., user #123) regardless of whether the user answers a prompt or not. In some instances, a server creates this unique identifier in response to the user answering one or more prompts on the website. For example, the system may prompt the user to answer various questions while the user navigates the website (e.g., a question about the user's t-shirt size). The system may prompt the user for their t-shirt size and may store the t-shirt size in the profile associated with the unique identifier #123. If the user provides identifying information at a later time (e.g., on the user's third visit to the website, the user may provide an email address), the system may add the answers in the temporary profile (e.g., the profile associated with the unique identifier #123) to a permanent profile for the user (e.g., a profile stored on a server associated with the email address of the user). In some instances, the system will transmit the subscribed user's profile to an integration (such as a third-party platform).

In some embodiments, the system may provide a tiered discount based on the data provided by the user. For example, when a new user provides an email address, the website may provide the new user with an incentive for 5% off of a total purchase price. In some embodiments, the website will prompt the user to complete a subsequent user action to receive the reward. For example, the user may have to select an option to add the reward to their shopping cart, or to view their shopping cart to see the reward. In other embodiments, the website may provide a reward to the user without requiring subsequent user action. For example, the system may add the reward to the user's shopping cart automatically after the user provides their email address. If the now-subscribed user answers additional prompts (e.g., if the subscribed user answers a question about the user's shoe size), the website may provide an additional incentive to the user. For example, for providing the shoe size, the system may increase the incentive from 5% off to 10% off. The system may generate a coupon code comprising the applicable tiered discount for the subscribed user and may maintain a database that comprises the coupon code for the subscribed user, and any associated unique discount/incentive (e.g., the applicable percentage of the tiered discount based on the user's responses).

In some embodiments, the system may generate a dynamic coupon code that the user may be able to use multiple times (e.g., the user may be able to use a coupon code five times). For example, the system may generate a dynamic coupon code for 5% off of a total purchase that the user may be able to use a total of five times. The system may track and maintain, via a database or a third-party integration, use of a multi-use dynamic coupon code.

In some embodiments, a server stores the permanent profile for the user (e.g., in a database on a server). In some embodiments, the user's local device also stores the permanent profile in a file local to the device (e.g., in a cookie). For example, subsequent to creating a permanent profile for the user, the user may have a profile stored on both the system local to the user and on a server that is remote from the user.

In some instances, the website prompts the subscribed user to provide additional zero-party data. For example, after the user provides an email address, the website may prompt the subscribed user to answer additional questions (e.g., when the subscribed user expects to make a purchase). In such instances, the website operator may use a form having one or more prompts to collect information about the subscribed user. In some embodiments, this form may be an embedded form as a part of a website or webpage. In some embodiments, this form may be a pop-up form triggered by, for example, a time, scroll, or action taken by a user. For example, the form may not trigger until a user reaches a page for a product. In some embodiments, the website operator may automatically provide options selected by a user in response to the prompts in a form to a server without requiring additional user input (e.g., selection of a send button). For example, every time a subscribed user answers a prompt in the form, the answer may update a file on a device local to the subscribed user and may update a profile of the subscribed user stored on a server.

In some embodiments, a browser that is local to the user may retrieve a logic mapping that dictates the flow of prompts in the form. For example, a device may download form data as a single file and may provide instructions to the browser without the need to query the server after each form response. In other embodiments, the server may use answers from the prompts to generate or select subsequent prompts. In such embodiments, the interface reduces the latency for providing additional prompts to the user, thereby increasing the usability and likeliness that the user completes the form. In other embodiments, the generation of the form and/or the prompts may be based on a logic mapping stored on the server.

The display of the prompts is based on a progression of the logic mapping. For example, the system may prompt the user for the user's interests. The website may subsequently show a user interested in apparel a prompt to indicate preference for sweat suits, loungewear, or dresses. Accordingly, the logic mapping allows for the system to dynamically collect the most relevant data based on prior user responses, thereby increasing the robustness of the collected data.

A device operated by a webpage user may download the form data once the user lands on a webpage and may upload the data in the form in the background as the user is completing the form. For example, when the user lands on a webpage, the device may download the entire form and mapping logic to a browser of the user. As the user is completing the form, the system may attempt to upload the user's responses to a server (e.g., after the user answers each prompt). Should the system receive an error when contacting the server (e.g., because of a temporary network outage), the system will attempt to re-upload the user's responses without requiring any intervention by the user. Accordingly, the user may complete the form without any latency, even when the device has not yet saved the form data. In some embodiments, the system may save a datapoint for each prompt the user answers and may update metrics for the form and/or website based on each data point. In some instances, the system may save datapoints and update metrics automatically on a server in response to receiving the user's responses. The server may generate the metrics to associate revenue to subscribed users and the zero-party data they have provided via a form.

In some instances, when a server creates a profile for the user (e.g., a subscribed user), the server adds information about the browsing actions and activities of the user to the profile of the user (e.g., first-party data). In some embodiments, the server does not add the first-party data to the profile of the user until the user subscribes (e.g., provides identifying information). For example, the systems described herein may track and store in the profile of the subscribed user how long it takes for the user to complete the form, how many questions the user answered, which page the user was on and when the user engaged with the form, any purchase information, and other information about the user from third-party platforms. In some instances, the information from third-party platforms includes metrics such as ad spend (e.g., how much it cost to place an ad for the website on a third-party platform), impressions (e.g., how many times users viewed an advertisement for the website on a third-party platform), clicks (e.g., how many times a user selected an advertisement for the website on a third-party platform), or various other types of engagement and campaign information. In some embodiments, the system may track first-party data prior to the user providing identifying information.

In some embodiments, the system incentivizes the user to provide identifying information, to provide additional information about the user, or to complete an action. For example, the system may generate a coupon code for the user in exchange for the user providing their email address, for providing additional information about the user (e.g., when the user expects to make a purchase), or to complete a purchase (e.g., discount off first purchase). Because the system dynamically collects data about both the users that complete an action (e.g., complete the form) and users that do not complete the action (e.g., users that only partially complete the form), the system can dynamically update the incentive structure and provide unique incentives to users based on the collected data. For example, the system may provide a user that only provides an email address an incentive for 5% off of one purchase, whereas the system may provide a user that provides an email address, a gender, and a shoe size an incentive for 10% off of three purchases. The coupon codes generated by the system may dynamically change based on any additional information provided by the user. For example, if the user choses to provide the gender and shoe size at a later date (e.g., subsequent to providing the email address) the system can dynamically change the incentive (e.g., from 5% off of one purchase to 10% off of three purchases) at that later time. Additionally, based on the collected data, the system can generate aggregated information about the user that the website operators can utilize to provide website analytics.

When a user navigates to a website and interacts with a form, the systems described herein may store the user's responses to the form and certain information related to the user's interaction with the form. For example, the system may store how long the user viewed the form, how many times the form was shown to the user, the time it took the user to respond to each prompt in the form, and the number of prompts in the form completed by the user. In some embodiments, the system stores form information and data in a file associated with a client ID (e.g., an ID associated with a file of a local browser on a user's client device). If the user leaves the website without completing the form and subsequently navigates to the website again at a later time (e.g., returns to the website the next day), the system automatically presents the form at the prompt where the user left off in the previous visit. In such embodiments, the form information and data from the user's current visit are associated, by the system, with the same client ID. The user may provide identifying information at a later time (e.g., the user provides an email address a week after browsing the website for the first time). In such a case, the system will generate a profile for the user upon the user providing the identifying information (e.g., the email address) and will add the zero-party data associated with the client ID to the profile (e.g., the responses to the form data that the user provides). By automatically including the data in the profile of the user (e.g., either after or before the user subscribes), the website operator has robust profile data about the user already upon account creation.

In some embodiments, the system described herein may track first-party data (i.e., the data a website operator collects from the browsing actions and activities of a user to the website through cookies. For example, the system may track what pages a user to a website views and how long the user views the pages. In some embodiments, the system may combine the first-party data with the zero-party data stored in the file associated with the client ID (e.g., an ID associated with a file of a local browser or on a remote server. In some embodiments, the system uses first-party data already stored in a profile of the user to target specific forms to the user.

In some embodiments, the system may use profile, form, and/or browsing data of a user to simplify an action on the website. For example, a subscribed user may answer questions about why the subscribed user is accessing a software as a service (“SaaS”) website. The system automatically retrieves the information in the profile of the user to determine where the user should land on the SaaS page. For example, if the subscribed user previously indicated that they are an IT professional, the SaaS website may provide them with an option to talk to another IT professional. In contrast, if the subscribed user previously indicated that they are not an IT professional, the SaaS website may provide the user with an option to talk to a general support representative.

In another example, a subscribed user may benefit from the system using profile information to automatically select options on the website. The system may select the information regardless of whether the subscribed user logs in or not (e.g., based on a cookie). For example, when the system determines that user is size “Medium” (e.g., based on a user answering a question about his/her size or based on determining that the user browses medium-sized clothing), the system may automatically select and display the medium sized clothing option when the user accesses a product page. By automatically selecting the medium-sized product option, the user can add an item to a cart without first requiring a selection of the size. This benefit reduces the friction for website users in completing a sale.

In some embodiments, the systems and methods described herein provide a user with an individualized user incentive that may be tiered or multi-use. For example, the system may provide the user with a percentage off of a total purchase price if the user provides the website with an email address. In response to receiving the email address, the system may generate a dynamic coupon code or static coupon code for the user. When the system generates the coupon code, it stores the coupon code in a profile of the subscribed user and/or in a coupon code and discount management database.

In some embodiments, the system may generate a dynamic coupon code for distribution to an affiliate or an influencer. The affiliate or influencer may distribute the dynamic coupon code to the affiliate's or influencer's audience. Each time the user uses the dynamic coupon code on the website, the system may update a database tracking uses of the coupon and may attribute the source of the user's visit to the influencer or affiliate. By tracking, in the database, the use of the dynamic coupon, a website operator can identify the most influential influencer, promotor, and/or affiliate, and can identify fraudulent use and distribution of coupon codes.

In some embodiments, the user may be able to use the dynamic coupon code one or more times (e.g., five times). The systems described herein store a maximum number of usages of a dynamic coupon code and track the number of times the user uses the dynamic coupon code. For example, in response to a user providing an email address to the system and providing a clothing size, the system may generate a dynamic coupon code that the user can use a maximum of five times. Each time that the user uses the dynamic coupon code on the website, the system may decrease the number of remaining uses for the dynamic coupon code. If the system allows a user to use a coupon code multiple times, the user is more likely to return to the website and to make future purchases on the website. Once the user has made multiple purchases on the website (e.g., with the coupon code), the user is more likely to return to the website to make additional purchases, even without the coupon code. In some instances, the system may automatically select the maximum number of uses of the coupon code based on data about the user, e.g., data about when the user expects to make a purchase. A user that expects to make a purchase in December, a busy shopping month, may receive a coupon code with a higher number of uses than a user that expects to make a purchase in May.

In some instances, when a new user first provides identifying information when completing a form, but subsequently provides identifying information a second time when completing an action (e.g., completing a purchase), the system may automatically link the profile to the first and second set of identifying information. For example, a new user may provide an email address that the user uses to collect spam when filling out a form but may use a primary email address when checking out on the website. The systems provided herein may automatically merge the information provided by the user in the form with the unique identifying information of the user provided during checkout to create a single merged profile, as opposed to two unique and separate profiles.

In some embodiments, the server receives user data and user actions from a plurality of user profiles from ad campaigns on websites because many different users with different client devices interact with web sites through ad campaigns and buy products on a regular basis. For example, a website selling shirts may present multiple users with forms asking about their shirt sizes. The website receives from one client device a selection of the option “size small” on the form and the user action of a purchase of a size small shirt. The same website receives from a different client device a selection of the option “size medium” as their shirt size and the user action of adding a size small shirt to their cart. In this embodiment, the server may generate aggregated received user data and aggregated received user actions from the plurality of stored profiles associated with the plurality of client devices. For example, the server may combine the revenue generated by the website into an aggregated revenue value and may identify which users have provided user data (e.g., a selection of a shirt size). The server may then generate an output corresponding to user engagement for each ad campaign, based on the aggregated received user data and the aggregated received user actions. For example, the server may generate a score that indicates how often users who interact with the form asking about shirt size complete purchases. In some embodiments, the score is generated based on a training a machine learning model. In some embodiments, the machine learning model is trained based on at least one of aggregated received user data, aggregated received user actions, insights, impressions, events, and metrics. In some embodiments, the trained machine learning model computes the output by inputting the aggregated received user data and the aggregated received user actions to input nodes of the trained machine learning model. In some embodiments, the trained machine learning model receives at least one of the insights, impressions, events, and metrics from a second server, remote from the first server (e.g., from a server of a third party).

In some embodiments, the system generates output by inputting the aggregated received user data and the aggregated received user actions to input nodes of a trained machine learning model. For example, the system may input all of the shirt size selections from the form, e.g., “size small,” “size medium,” and all of the user actions on the website, e.g., purchase of a size small shirt, adding a size medium shirt to the shopping cart, into the input nodes of the machine learning model. In one instance, the system trains the machine learning model based on insights, impressions, events, and metrics, for example, clicks, click-through rate, cost per million impressions, cost per clicks, views, subscriptions, subscription percentage, cost per subscriber, subscriber orders, subscriber revenue, subscriber sales percentage, non-subscriber revenue, total orders, total revenue, spend, customer acquisition cost, and return on ad spend. In some embodiments, remote servers associated with integrations (e.g., third-party platforms) transmit the insights, impressions, events, and metrics. For example, the system may purchase insights, impressions, events, and metrics that the system may not be able to gather on its own, from third-party platforms. The system may then use the purchased insights, impressions, events, and metrics to train the machine learning model.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1 is an illustrative example of a system for measuring the strength of a user engagement strategy including zero-party data over a network, in accordance with some embodiments of the present disclosure;

FIG. 2A shows an illustrative diagram of a model, in accordance with some embodiments of the present disclosure;

FIG. 2B shows an additional illustrative diagram of a model, in accordance with some embodiments of the present disclosure;

FIG. 3 is an illustrative example of a system for receiving insights, impressions, events, and metrics from remote servers, in accordance with some embodiments of the present disclosure;

FIG. 4 is an illustrative diagram of an example data format, in accordance with some embodiments of the present disclosure;

FIG. 5 shows an illustrative diagram of a network configuration, in accordance with some embodiments of the disclosure;

FIG. 6 shows an illustrative diagram of a computer system, in accordance with some embodiments of the disclosure;

FIG. 7 is an illustrative example of a multi-action form, in accordance with some embodiments of the present disclosure;

FIG. 8 is an illustrative example of a system for providing and storing a reward to a profile associated with a client device, in accordance with some embodiments of the present disclosure;

FIG. 9 is an illustrative example of a system for providing and storing a reward to a profile associated with a client device, in accordance with some embodiments of the present disclosure.

FIG. 10 is an illustrative example of a system for providing and storing a reward to a profile associated with a client device without requiring subsequent user action, in accordance with some embodiments of the present disclosure.

FIG. 11 shows a flowchart of an illustrative process for measuring the strength of a user engagement strategy including zero-party data over a network, in accordance with some embodiments of the present disclosure;

FIG. 12 shows a flowchart of an illustrative process for detecting and creating user profiles associated with client devices, in accordance with some embodiments of the present disclosure; and

FIG. 13 shows a flowchart of an illustrative process for monitoring remaining uses of a code for a user profile, in accordance with some embodiments of the present disclosure.

FIG. 14 shows a flowchart of an illustrative process for training a machine learning model based on insights, impressions, events, and/or metrics of a user engagement campaign, user data, and user actions, in accordance with some embodiments of the present disclosure.

### DETAILED DESCRIPTION

Systems and methods are described herein for measuring the strength of a user engagement strategy including zero-party data over a network. In the following description, numerous specific details are set forth to provide thorough explanation of embodiments of the present disclosure. It will be apparent, however, to one skilled in the art, that embodiments of the present disclosure may be practiced without all of these specific details. In other instances, certain components, structures, and techniques have not been shown in detail in order not to obscure the understanding of this description.

The processes depicted in the figures that follow are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially. The system and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, random access memory (“RAM”), a solid state drive (“SSD”), etc.

The systems and methods described herein provide a method for a server generating an output corresponding to user engagement. This output is generated by inputting aggregated received user data and aggregated received user actions from websites to input nodes of a machine learning model that has been trained based on insights, impressions, events, and metrics. In one instance, the insights, impressions, events, and metrics are received from a remote server, for example, a remote server associated with a third-party platform integration. In some embodiments, the aggregated received user data are received by the server from forms with user-interactive response fields on webpages, and the aggregated received user actions are received by the server from files stored on client devices that track actions users take on websites. Oftentimes, users are incentivized with rewards to provide responses to the forms, and to perform user actions, such as purchasing or viewing products on the website. In some embodiments, the received user data and received user actions are stored on profiles on the server, the profiles corresponding to the client devices that are transmitting the user data and performing the user actions.

As referred to herein, “third-party data” is data companies collect about an individual from following the individual around the Internet (e.g., by tracking the individual's Internet protocol (IP) address through cookies, pixels or other tracking technologies). As referred to herein, “profile” is the data comprised of the subscribed user in an e-commerce platform or tool, including contact information. As referred to herein, “new user” is an individual who is visiting a website for the very first time. As referred to herein, “returning user” is an individual that has previously visited the website. As referred to herein, “dynamic coupon code” means a unique coupon code created specifically for the eligible user (e.g., in exchange for identifying information) for use by the applicable user for purchases made through the e-commerce store. As referred to herein, “form” means a form that presents information and/or collects zero-party data from a user (e.g., displaying an offer for a discount, a sign-up form, a quiz).

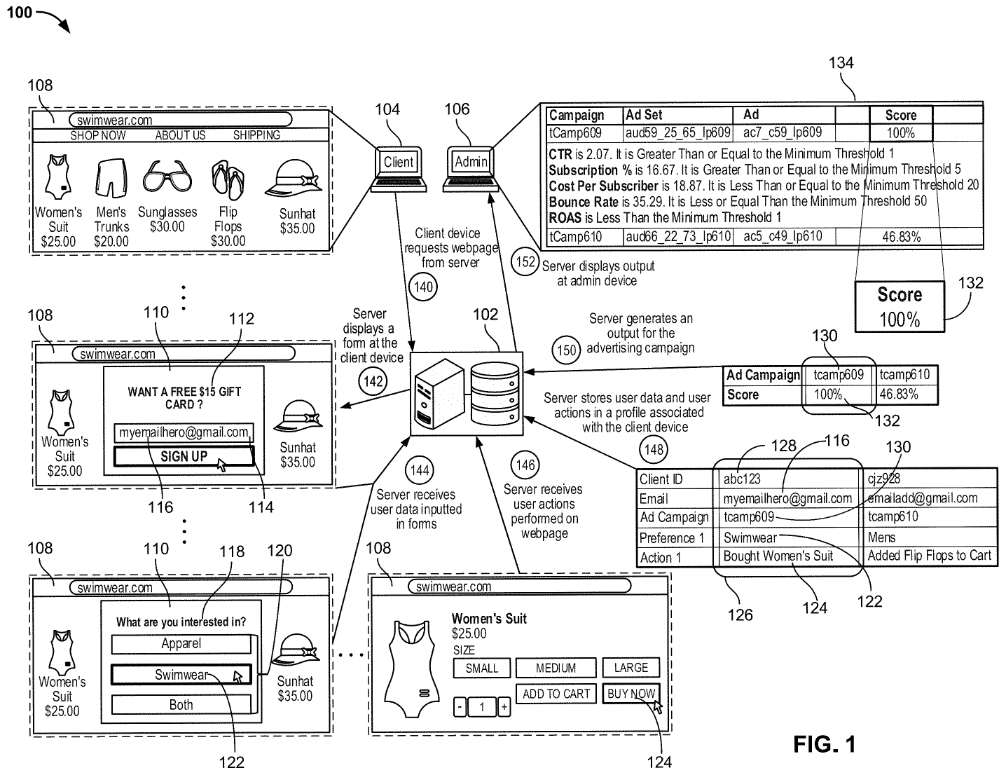

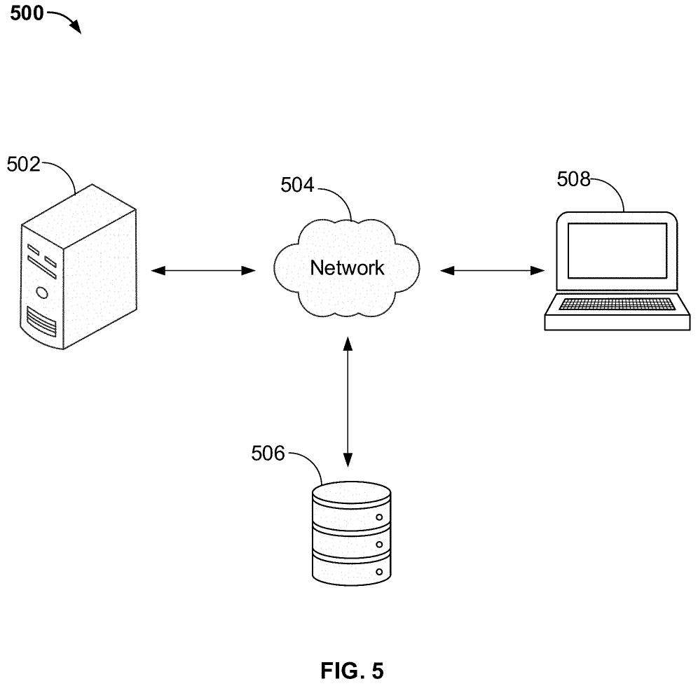

FIG. 1 is an illustrative example of a system for measuring the strength of a user engagement strategy including zero-party data over a network, in accordance with some embodiments of the disclosure. System 100 may be implemented in software and or/hardware using a computing device, such as server 102. System 100 is depicted having server 102, client device 104, administrative device 106, webpage 108, form 110, subscription incentive 112, user-interactive response field 114, user identification information 116, prompt 118, user-interactive response fields 120, user preference information 122, user action 124, user profile 126, client ID 128, advertising campaign ID 130, output 132, and dashboard 134. System 100 may include additional servers, devices and/or networks, such as any of the devices described further below with respect to FIG. 5. For example, functionality of server 102 may be shared between several servers, providing a cloud computing solution.

In some examples, the actions outlined within system 100 are performed by server 102, or any other servers, devices and/or networks, such as any of the devices described further below with respect to FIG. 5. For example, a non-transitory memory of server 102 and/or a non-transitory memory of administrative device 106 may store instructions that, when executed by processors of those devices, cause execution of the actions outlined within system 100.

In some embodiments, at action 140, server 102 receives a request for webpage 108 from client device 104, causing the client device 104 to display webpage 108. For example, a user types the web address “swimwear.com” in the browser of client device 104, and server 102 causes client device 104 to display the webpage for “swimwear.com.”

In some embodiments, at action 142, server 102 causes form 110, associated with advertising campaign ID 130, to be displayed on webpage 108 on client device 104. For example, form 110 may be a part of an advertising campaign that has advertising campaign ID 130 that has the goal of encouraging users to purchase apparel and swimwear from swimwear.com. In some instances, server 102 causes form 110 to present subscription incentive 112 and user-interactive response field 114. Subscription incentive 112, for example, text saying, “Want a Free $15 Gift Card?” and a selectable option to “sign up,” may cue a user to input user identification information 116, for example, a user's email address, into user-interactive response field 114.

In some embodiments, server 102 may cause form 110 to present prompt 118 with one or more other user-interactive response fields 120 that populate in response to inputs provided to previous user response fields. For example, the prompt may be text asking, “What are you interested in?” and the one or more user-interactive response fields 120 may be selectable options with preset answers to prompt 118, such as three selectable buttons that say “Apparel,” “Swimwear,” and “Both,” respectively. The one or more user-interactive response fields 120 may also be open fields that can receive text inputted by a user, for example, a text box. The one or more user-interactive response fields 120 may cue a user to answer prompt 118 requesting user preference information 122 (e.g., a preference for apparel, swimwear, or both apparel and swimwear). In some instances, server 102 may cause form 110 to present multiple prompts in the same way as prompt 118. The subsequent prompts may request different user preference information than user preference information 122, in response to inputs being provided to previous user response fields. For example, server 102 causes form 110 to display a request for a user's email address. Once server 102 receives an email address via form 110, server 102 may cause form 110 to display a prompt for the user to answer, “What are you interested in?” When server 102 receives a response of “Swimwear,” server 102 may cause form 110 to display a prompt, “What type of suits do you prefer?” Server 102 may receive a response of “trunks.” Server 102 may cause any number of prompts 118 to be displayed by form 110 in response to inputs being provided to previous user response fields.

In some embodiments, server 102 causes form 110 to present prompt 118 requesting user preference information 122 prior to presenting a subscription incentive 112 requesting user identification information 116. In this case, server 102 may cause form 110 to present subscription incentive 112 requesting user identification information 116 in response to inputs being provided to previous user response fields. For example, server 102 causes form 110 to display a prompt for the user to answer, “What are you interested in?” and receives a response of “Swimwear.” Once server 102 receives the response of “Swimwear,” server 102 causes form 110 to display a request for the user's email address.

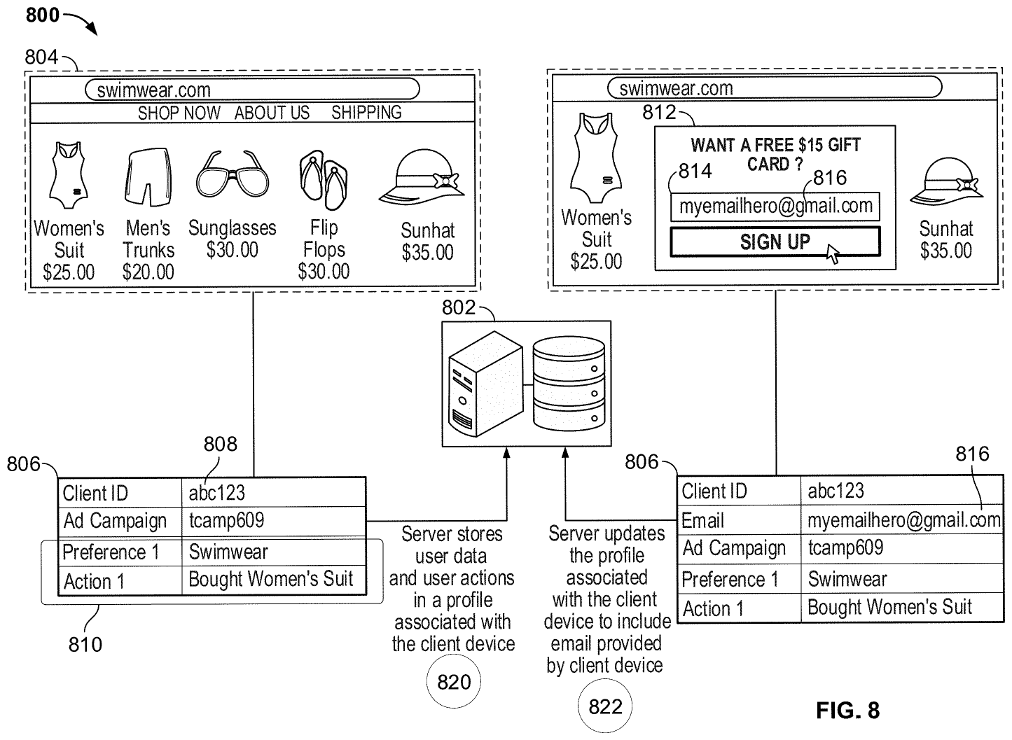

In some embodiments, server 102 may cause form 110 to present only prompt 118 requesting user preference information 122 without presenting subscription incentive 112 requesting user identification information 116. In this instance, server 102 may receive user identification information 116 at a later time, as described further below with respect to FIG. 8.

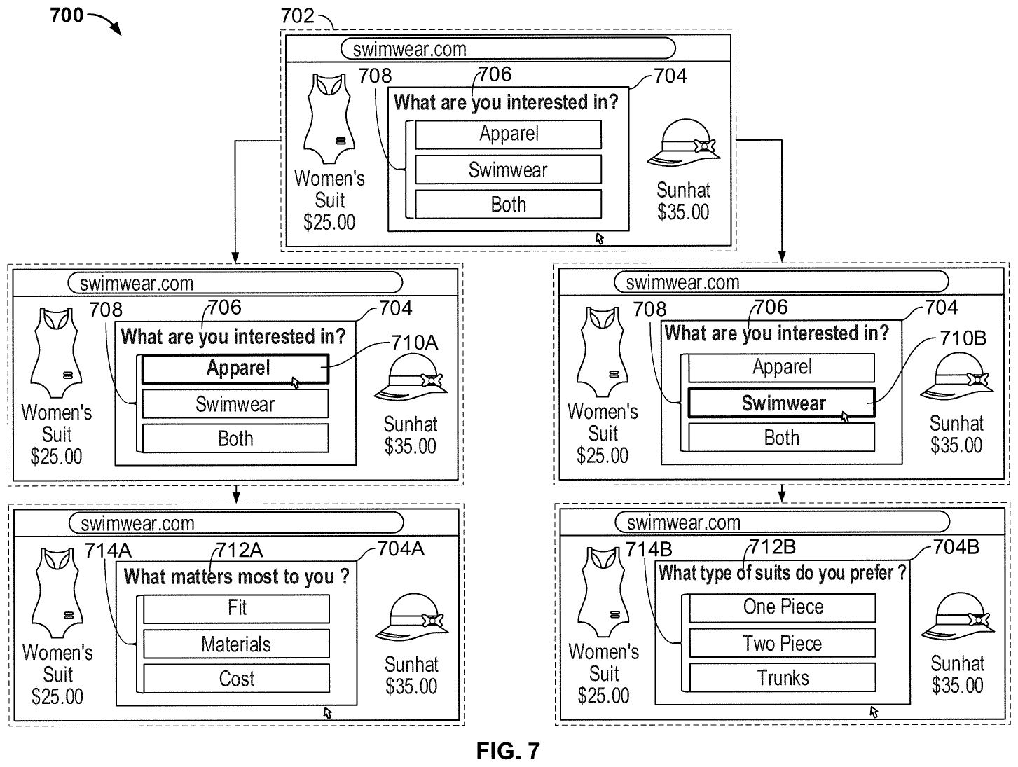

In some embodiments, form 110 comprises a multi-action form that uses responses to prompts 118 to generate or select subsequent prompts based on a progression of a logic mapping, as described further below with respect to FIG. 7.

In some embodiments, at action 144, server 102 receives the user data (e.g., one or more of user identification information 116 and user preference information 122) inputted within user-interactive response fields 114 and 120. For example, client device 104 may transmit the user data (e.g., one or more of user identification information 116 and user preference information 122) to server 102 over a network automatically as the data is inputted within form 110.

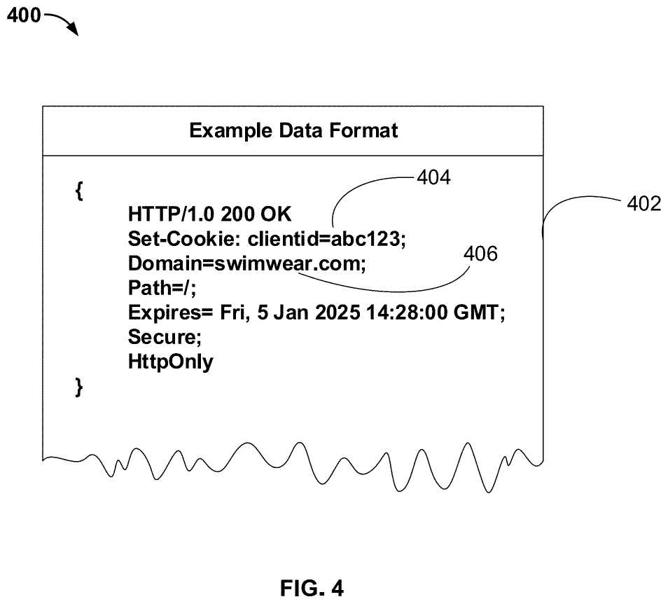

In some embodiments, at action 146, server 102 receives one or more user actions 124 performed on webpage 108. User actions 124 may be, for example, one or more of a purchase of a swimsuit, adding a hat to a shopping cart, or viewing color choices for a pair of flip-flops. Server 102 may receive user actions 124 via, for example, a first-party cookie embedded in webpage 108 on client device 104, as described further below with respect to FIG. 4.

In some embodiments, at action 148, server 102 stores the received user data (e.g., one or more of user identification information 116 and user preference information 122) from action 144 and the received user actions 124 from action 146 in user profile 126 associated with client device 104. In some embodiments, the user profile 126 contains client ID 128 to identify client device 104. The client ID may be, for example, a string of characters, e.g., “abc123.” In some embodiments, the user profile 126 contains advertising campaign ID 130, to identify the advertising campaign associated with form 110. The advertising campaign ID 130 may be, for example, a string of characters, e.g., “tcamp609.” In some embodiments, the user profile 126 comprises client ID 128, user identification information 116, advertising campaign ID 130, user preference information 122, and user actions 124.

Server 102 stores a plurality of user profiles 126 comprising received user data (e.g., one or more of user identification information 116 and user preference information 122) and received user actions 124 for a plurality of advertising campaigns IDs 130 across a plurality of webpages 108. Server 102 generates aggregated received user data (e.g., one or more of user identification information 116 and user preference information 122) and aggregated received user actions 124 for each advertising campaign across the plurality of user profiles 126 stored in server 102.

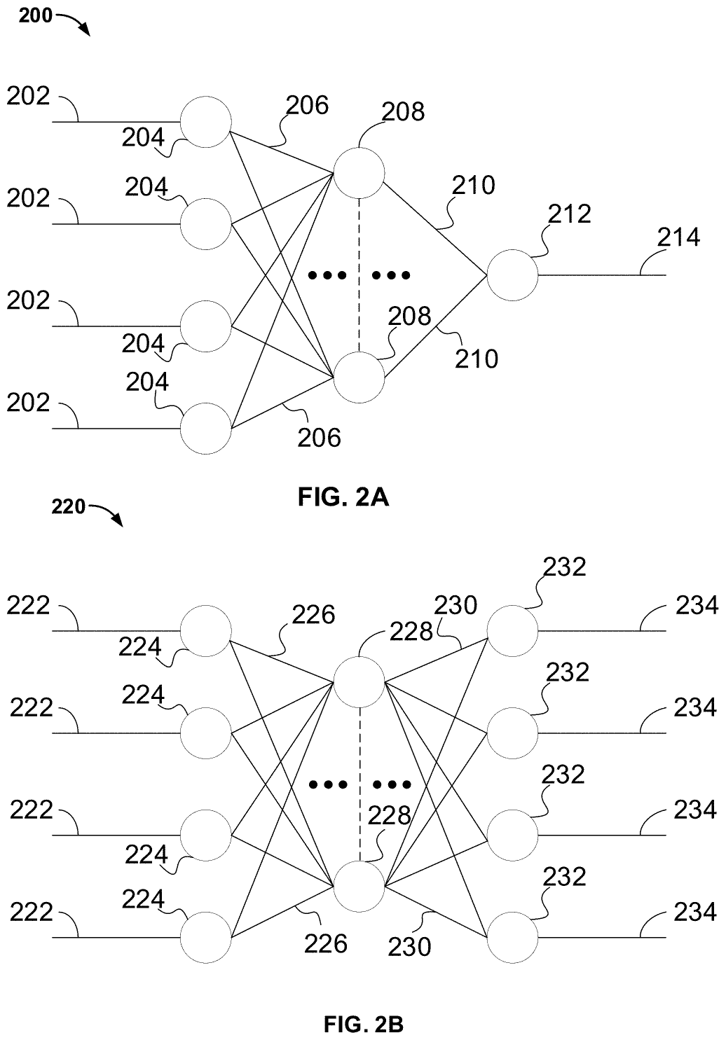

In some embodiments, at action 150, server 102 generates output 132 for the advertising campaign ID 130. Output 132 is based on the aggregated received user data (e.g., one or more of user identification information 116 and user preference information 122) and aggregated received user actions 124 for each advertising campaign across the plurality of user profiles 126 stored in server 102. Server 102 may generate output 132 using a trained machine learning model, as described further below with respect to FIG. 2. In some embodiments, output 132 is a score representing the strength of the advertising campaign with respect to, for example, user engagement. Output 132 may be a percentage out of 100%, e.g., 48%, representing the strength of the advertising campaign compared to other advertising campaigns. For example, if a user of administrative device 106 is monitoring first advertising campaign 130 and a second advertising campaign, server 102 may compute an output for first advertising campaign 130 and the second advertising campaign. Server 102 may scale the outputs such that the higher output becomes 100%, and the lower output is scaled based on the higher output to be a lower percentage, e.g., 67%.

In some embodiments, at action 152, server 102 displays output 132 on dashboard 134 on administrative device 106. In this instance, administrative device 106 is the device associated with the creators of the advertising campaign associated with advertising campaign ID 130. In addition to output 132, dashboard 134 may display any number of additional metrics associated with the advertisement campaign. For example, additional metrics may comprise insights on the aggregated received user data (e.g., one or more of user identification information 116 and user preference information 122) and aggregated received user actions 124 for each advertising campaign, and insights, impressions, events, and metrics, as described further below with reference to FIG. 2. Dashboard 134 may display multiple outputs 132 associated with multiple advertising campaign IDs 130, with additional metrics related to each advertising campaign.

The aspects outlined in system 100 may be combined in any suitable combination, taken in part, or as a whole.

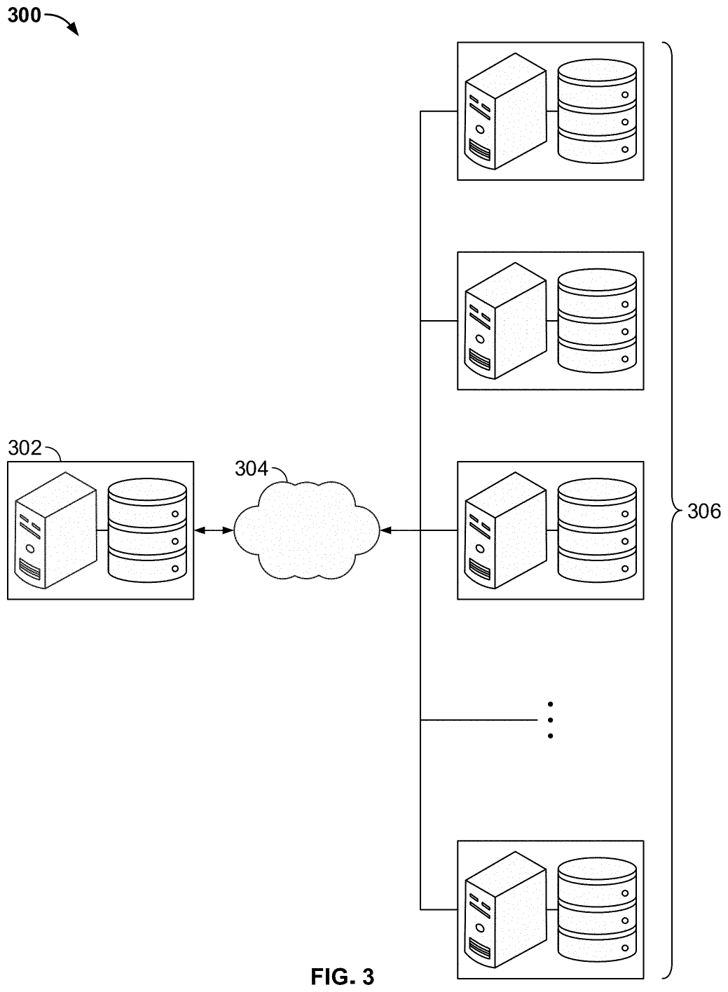

FIG. 2A and FIG. 2B show illustrative diagrams of models, in accordance with some embodiments of the present disclosure. Model 200 and model 220 may be implemented in a software and/or hardware computing device, such as server 102 within FIG. 1, or any other servers, devices and/or networks, such as any of the devices described further below with respect to FIG. 5. Server 102 may train model 200 and/or model 220 using insights, impressions, events, and metrics received at the server from remote servers, for example, the remote servers depicted further below with respect to FIG. 3. In some embodiments, model 200 and/or model 220 is based on a neural network. Although models 200 and 220 are depicted as neural networks, an artificial intelligence algorithm may be used without departing from the scope of the present disclosure, such as a linear regression, logistic regression, decision tree, Naïve Bayes, K-nearest neighbors, learning vector quantization, support vector machine, and/or bagging random forest.

In some embodiments, server 102 computes a single value based on multiple inputs. For example, model 200 may receive a plurality of input data for a user engagement campaign and may determine, via the trained neural network, a single output value, such as a score for the user engagement campaign, based on the input data. In some embodiments, server 102 computes multiple output values based on multiple inputs. For example, model 220 may receive a plurality of input data for a user engagement campaign and may determine, via the trained neural network, multiple outputs, such as a score for the user engagement campaign and a recommendation for whether to continue or end a user engagement campaign.

In some embodiments, server 102 may modify weights applied to at least one of the insights, impressions, events, and/or metrics based on use case of a specific engagement campaign. For example, server 102 may give a click-through rate a higher weight in a first user engagement campaign than the click-through rate for a second user engagement campaign. In some embodiments, server 102 may select the weights based on parameters specific to a client.

Model 200 is depicted having input nodes 204, hidden nodes 208, and output node 212. Input nodes 204 are connected to hidden nodes 208 via connection 206, and hidden nodes 208 are connected to output node 212 via connection 210. Model 220 is depicted having input nodes 224, hidden nodes 228, and output nodes 232. Input nodes 224 are connected to hidden nodes 228 via connection 226, and hidden nodes 228 are connected to output nodes 232 via connection 230. Although models 200 and 220 are depicted having only three layers, any number of layers may be present, each layer may comprise any number of nodes and each node may have any number of connections to other nodes. Input data elements 202/222 are provided as input to input nodes 204/224, and output data element(s) 214/234 are the output generated by model 200 or 220 from output node 212 or output nodes 232.

Server 102 may train models 200/220 by first assigning weights to connections 206, 210, 226, and 230. Server 102 may initially assign weights to connections 206, 210, 226, and 230 based on an approximation of the distribution of weights, may randomly assign weights (e.g., a randomly assigned value between zero and one), or may initialize all weights to the same value (e.g., all 0.1). In some embodiments, server 102 may select the weights based on parameters specific to a client (e.g., an expected importance of various engagement campaign data parameters for a client).

After assigning weights to connections 206, 210, 226, and 230, server 102 may compare the output of the model to determine whether it corresponds to the provided input. For example, for a user engagement campaign where users who provided an email address purchased approximately $100 worth of goods may receive a more positive output (e.g., higher score) than a user engagement campaign where users who provided an email purchased approximately $10 worth of goods. If server 102 determines that the output of model 200/220 was not what server 102 expected (e.g., a higher score is given to the user engagement campaign having a lower revenue), server 102 may update weights 206, 210, 226, and 230 to provide the desired results. For example, a user engagement campaign having a higher revenue is given a higher score and a “monitor” recommendation, whereas a user engagement campaign having a lower revenue is given a lower score and a “stop” recommendation.

While model 200/220 is depicted having four input nodes 204/224, any number of input nodes may be used without departing from the scope of the present disclosure. In some embodiments, server 102 may select the number of input nodes 204/224 to model 200/220 based on the number of datapoints tracked in a user engagement campaign. For example, the input to input nodes 202/224 may comprise at least one of the insights, impressions, events, and/or metrics of a user engagement campaign. In some embodiments, the input to model 200/220 is a vector comprising insights, impressions, events, and/or metrics of a user engagement campaign, where each element in the vector corresponds to an input node 204/224.

Server 102 may provide input data elements 202/222 as the input to input nodes 204/224. In some embodiments, server 102 may compute values for hidden nodes 208/228 based in the input applied to input nodes 204/224 and the weights of connections 206/226. As an example, when the weights of connections 206/226 are all 0.1 (e.g., because they were instantiated to initial values of 0.1) and the values of input nodes 204/224 are all 1, server 102 may compute the values for hidden nodes 208/228 to be all 0.4. Although model 200/220 is depicting only having one layer of hidden nodes, any number of layers having hidden nodes may be present in model 200/220. In some instances, hidden nodes 208/228 represent the most compressed version of input data elements 202/222. In some instances, the number of input nodes 204/224 may be larger than the number of hidden nodes 208/228. In such instances, when server 102 computes the values for hidden nodes 208/228 from the values of input nodes 204/224, server 102 encodes the input data to a compressed form (e.g., fewer nodes represent the input data).

Server 102 may compute the value for output node 212 and/or nodes 232 based on connections 210 between hidden nodes 208 and output node 212 and/or based on connections 230 between hidden nodes 228 and output nodes 232. For example, server 102 may assign all connections 230 weights of 1. Server 102 may compute the value of output nodes 232 to be 0.8. When computing the value for output nodes 232, server 102 may decode input data from a compressed form to a decompressed form.

In some embodiments, server 102 may compute an error value between input data elements 202/222 and output data element(s) 214/234 to generate an error value and may update the weights between nodes based on the error value. For example, server 102 may compute a first error value corresponding to output data element(s) 214/234 (e.g., having a value of 0.8) by subtracting 0.8 and an expected output value (e.g., an expected output value of 0.9 for the input values applied via input nodes 204/224). In such instances, server 102 may use the error value to tweak the weights for connections 206 and 210/226 and 230 between input nodes 204/224 and output node(s) 212/232. Server 102 may continue an iterative process of updating the weights for various connections in the model until it finds an appropriate fit for the data (e.g., the error value is an acceptable value such that model 200/220 is not overfit to input data nor is it underfit to input data elements).

In some embodiments, server 102 may compute the output data element(s) 214/234 using weighted averages of the input data elements 202/222. In such embodiments, models 200/220 may comprise one or more input nodes 204/224 connected to output nodes 212/232 without an interstitial hidden node layer (e.g., nodes 208/228). Server 102 may assign the weights between input nodes 204/224 and output node(s) 212/232 such that input nodes having higher importance to an engagement campaign have a higher weight. For example, when subscription rate is a more important metric to an engagement campaign than, for example, a bounce rate, server 102 may assign a higher weight to the subscription rate than to the bounce rate when computing values for output node(s) 212/232.

The aspects outlined of models 200 and 220 may be combined in any suitable combination, taken in part, or as a whole.

FIG. 3 is an illustrative example of a system for receiving insights, impressions, events, and metrics from remote servers, in accordance with some embodiments of the present disclosure. System 300 includes server 302, cloud network 304, and one or more remote servers 306. In some embodiments, server 302 is the same server as server 102 within FIG. 1.

In some embodiments, system 300 outlines further details of action 150 within FIG. 1, in which server 102 generates output 132 for the advertising campaign associated with advertising campaign ID 130. In some embodiments, system 300 outlines further details of FIG. 2, explaining the origins of the insights, impressions, events, and metrics server 102 uses to train the machine learning model 200 or 220.

System 300 may include additional servers, devices and/or networks, such as any of the devices described further below with respect to FIG. 5. For example, functionality of server 302 may be shared between several servers, providing a cloud computing solution.

Server 302 is connected to cloud network 304, for example, network 504 as described further below with respect to FIG. 5. The one or more remote servers 306 are also connected to cloud network 304, thus allowing remote servers 306 to send data through cloud network 304 to server 302 and allowing server 302 to send data through cloud network 304 to remote servers 306. In some embodiments, remote servers 306 store the insights, impressions, events, and metrics that server 102 uses to train the machine learning model 200 or 220, and transmit the insights, impressions, events, and metrics to server 302 via cloud network 304. In some embodiments, remote servers 306 are tracking users of a plurality of webpages through files, e.g., cookies, embedded in webpages in order to gather and store insights, impressions, events, and metrics, e.g., third-party data, associated with user engagement. In some embodiments, remote servers 306 link third-party data to users using an application programming interface (API). In some instances, remote servers 306 can use the API to communicate with various different software implementations for various different services. In some embodiments, server 302 may collect insights, impressions, events, and metrics on its own, without receiving them from remote servers 306.

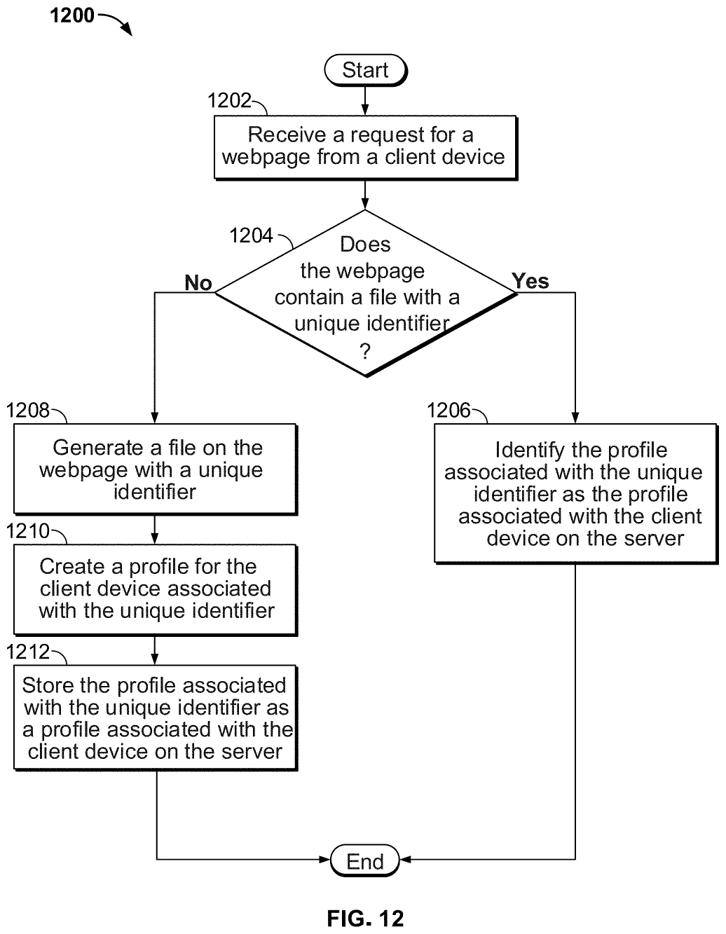

FIG. 4 is an illustrative diagram of an example data format. System 400 is depicted having example data format 402, client ID 404, and domain name 406. Server 102 may store system 400 in response to a user accessing a webpage (e.g., webpage 108 discussed further above with respect to FIG. 1) on a computing device (e.g., client device 104 discussed further above with respect to FIG. 1). Server 102 may generate example data format 402 based on requests for webpages from client devices, as described further below with respect to FIG. 12. In some embodiments, server 102 has stored example data format 402 on the webpage of the client device identified by client ID 404 in example data format 402 (e.g., client device 104 and webpage 108 discussed further above with respect to FIG. 1). In some embodiments, user ID 404 may be client ID 128 as discussed further above with respect to FIG. 1. In some embodiments, user ID 404 may be a string of characters, e.g., “abc123.” In some embodiments, server 102 or client device 104 generates the client ID by generating a cookie stored on the user's local machine. In some embodiments, server 102 or client device 104 generates the client ID automatically when a new user first accesses a website. In some embodiments, example data format 402 has the domain name 406 of the webpage that example data format 402 is on (e.g., webpage 108 discussed further above with respect to FIG. 1), for example, “swimwear.com.”

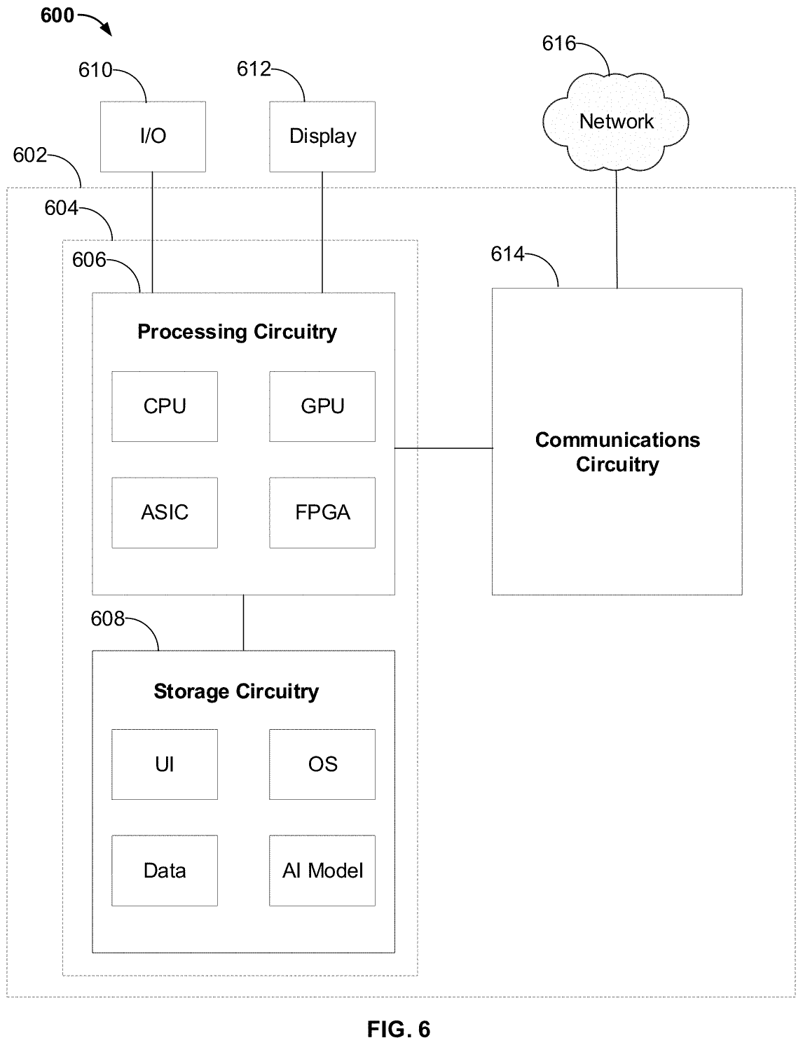

FIG. 5 shows an illustrative diagram of a network configuration. System 500 is depicted having server 502, network 504, database 506 and client 508. While FIG. 5 depicts only one type of each device to avoid over complicating the drawing, additionally, various configurations of devices and networks may be implemented without departing from the scope of the present disclosure. Server 502 may include one or more computing devices (e.g., computing device 600 discussed further below with respect to FIG. 6) and may implement system 500 and/or any of the components, systems, or processes, described above or below. Server 502 is communicatively coupled to client 508 and database 506 via network 504. Network 504 may be any component or device that enables server 502 to communicated to database 506 and/or client 508. In some embodiments, database 506 may be implemented on a remote device (e.g., a server on a different local network than server 502). In such instances server 502 may communicate with database 506 over an ethernet connection of server 502 that is connected to the Internet via a router of network 504. In some embodiments, database 506 is local to server 502. In such instances server 502 may communicate to database 506 via Serial ATA bus.

Database 506 may store any data and/or dataset descried herein, such as received user data (e.g., one or more of user identification information 116 and user preference information 122), as described above with reference to FIG. 1, and insights, impressions, events, and metrics, as described above with reference to FIG. 2. System 100 may retrieve any of received user data (e.g., one or more of user identification information 116 and user preference information 122), as described above with reference to FIG. 1, and insights, impressions, events, and metrics from database 506 to perform the processes described herein. In some embodiments, database 506 is implemented on a computing device, such as computing device 600, having a general-purpose processor. In such embodiments, some of the elements of the processes and methods described herein may occur on server 502 serially or in parallel to processing occurring on database 506.

Client 508 is communicatively coupled to server 502 and/or database 506 via network 504. Client 508 may be implemented on a computing device, such as computing device 600. In some embodiments, client 508 stores (e.g., either locally or remote from client 508) a trained model (e.g., a machine learning model).

FIG. 6 shows an illustrative diagram of a computer system. Computing device 600 is depicted having components that are internal and external to computing device 600, for example, internal components 602 includes control circuitry 604, which includes processing circuitry 606 and storage 608, and communications circuitry 614. External components may include input/output (hereinafter “I/O”) path 610, display 612 and network 616. In some embodiments, any of I/O path 610, display 612 and network 616 may be included as internal components 602.

I/O path 610 may provide content and data to control circuitry 604 and control circuitry 604 may be used to send and receive commands, requests, and other suitable data using I/O path 610. I/O path 610 may connect control circuitry 604 (and specifically processing circuitry 606) to one or more communications paths (described below). I/O functions may be provided by one or more of these communications paths but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), GPUs, etc., and may include a multiple parallel processing cores or redundant hardware. In some embodiments, processing circuitry 606 may be distributed across multiple separate processors or processing units, for example, multiple of the same type of processors or multiple different processors. In some embodiments, control circuitry 604 executes instructions for system 100 stored in memory (i.e., storage 608). Specifically, control circuitry 604 may be instructed by system 100 to perform the functions discussed above and below. For example, system 100 may provide instructions to control circuitry 604 to generate received user data (e.g., one or more of user identification information 116 and user preference information 122), as described above with reference to FIG. 1, and insights, impressions, events, and metrics, and/or any other type of data. In some implementations, any action performed by control circuitry 604 may be based on instructions received from system 100.

In some embodiments, control circuitry 604 may include communications circuitry 614 suitable for communicating with other networks (e.g., network 616) or servers (e.g., server 502 or database 506). The instructions for carrying out the above-mentioned functionality may be stored on database 506. Communications circuitry 614 may include a modem, a fiber optic communications device, an Ethernet card, or a wireless communications device for communicating with other devices. Such communications may involve the Internet or any other suitable communications networks or paths (e.g., via network 616/504). In addition, communications circuitry 614 may include circuitry that enables peer-to-peer communication between devices.

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, or any other suitable fixed or removable storage devices, and/or any combination of the same. Storage 608 may be used to store various types of data herein, such as user data Nonvolatile memory may also be used (e.g., to launch a boot-up routine and other instructions). Cloud-based storage (e.g., database 506 when connected to server 502 communicatively coupled to server 502 via the Internet) may be used to supplement storage circuitry 608 or instead of storage 608.

A user may send instructions to control circuitry 604 using I/O path 610 using an external device such as a remote control, mouse, keyboard, touch screen, etc. In some embodiments, control circuitry 604 correlates a user input with a location of a user interface element and performs an action based on the selected user interface element. Display 612 may be provided as a stand-alone device or integrated with other elements of computing device 600. For example, display 612 may be a touchscreen or touch-sensitive display and may be combined with I/O path 610.

System 100 may be implemented using any suitable architecture. For example, it may comprise a stand-alone application wholly implemented on computing device 600. In such an approach, instructions of the application are stored locally (e.g., in storage 608). In some embodiments, system 600 comprises a client-server-based application. Data for use by a thick or thin client implemented on computing device 600 is retrieved on-demand by issuing requests to a server remote from the computing device 600. In some embodiments, system 100 comprises instructions that are downloaded and interpreted or otherwise run by an interpreter or virtual machine (e.g., run by control circuitry 604).

FIG. 7 is an illustrative example of a multi-action form, in accordance with some embodiments of the present disclosure. Exemplary data format 700 includes webpage 702, form 704, initial prompt 706, initial user-interactive response fields 708, user response option one 710A, user response option two 710B, form iteration one 704A, form iteration two 704B, prompt iteration one 712A, prompt iteration two 712B, user-interactive response fields iteration one 714A, and user-interactive response fields iteration two 714B. In some embodiments, webpage 702 is the same as webpage 108 in FIG. 1, and form 704 is the same as form 110 in FIG. 1. In some embodiments, exemplary data format 700 outlines further details of action 142 within FIG. 1, in which server 102 displays form 110 at client device 104, and action 144 within FIG. 1, in which server 102 receives user data inputted in form 110.

In some embodiments, the process outlined within exemplary data format 700 is performed by server 102 of FIG. 1 on client device 104 of FIG. 1. For example, a non-transitory memory of client device 104 of FIG. 1 (e.g., storage 608) may store instructions that, when executed by processors of client device 104, cause server 102 to execute the process outlined within exemplary data format 700.

In some embodiments, server 102 causes form 704 to be displayed on webpage 702 on client device 104. In some embodiments, form 704 contains initial prompt 706 and initial user-interactive response fields 708. For example, the prompt may contain the text, “What are you interested in?” and the initial user-interactive response fields 708 may be selectable options with the text “Apparel,” “Swimwear,” and “Both.” In some embodiments, when server 102 receives user response option one 710A, for example, a user selection of “Apparel,” server 102 populates form iteration one 704A. Iteration one 704A may contains prompt 712A, for example, the text “What matters most to you?” and user-interactive response fields iteration one 714A, for example, selectable options with the text “Fit,” “Materials,” and “Cost.”

In some embodiments, when server 102 receives user response option two 710B, for example, a user selection of “Swimwear,” server 102 populates form iteration two 704B. Form iteration two 704B may contain prompt 712B, for example, the text “What type of suits do you prefer?” and user-interactive response fields iteration two 714B, for example, selectable options with the text “One Piece,” “Two Piece,” and “Trunks.”

In this way, form 704 is a multi-action form that uses responses to prompts to generate or select subsequent prompts, based on a progression of a logic mapping. For example, server 102 chooses to populate on client device 104 form iteration 704B, which contains a prompt and user-interactive response fields that are related to swimwear, because server 102 received user response option two 710B, indicating a user interest in swimwear. In some embodiments, when server 102 receives user response option one 710A indicating an interest in apparel, server 102 populates form iteration 704A on client device 104.

FIG. 8 is an illustrative example of a system for providing and storing a reward to a profile associated with a client device, in accordance with some embodiments of the present disclosure. System 800 includes server 802, webpage 804, user profile 806, client ID 808, user data and user actions 810, form 812, user-interactive response field 814, and user identification information 816. In some embodiments, server 802 is the same as server 102 in FIG. 1. In some embodiments, webpage 804 is the same as webpage 108 in FIG. 1. In some embodiments, client ID 808 is the same as client ID 128 in FIG. 1. In some embodiments, user data and user actions 810 are the same as user preference information 122 and user actions 124 in FIG. 1. In some embodiments, user-interactive response field 814 is the same as user-interactive response field 114 in FIG. 1. In some embodiments, user identification information 816 is the same as user identification information 116 in FIG. 1. In some embodiments, server 802 displays webpage 804 on a client device, such as client device 104 within FIG. 1. System 800 may include additional servers, devices and/or networks, such as any of the devices described above with respect to FIG. 5. For example, functionality of server 802 may be shared between several servers, providing a cloud computing solution.

In some examples, the actions outlined within system 800 are performed by server 802, or any other servers, devices and/or networks, such as any of the devices described above with respect to FIG. 5. For example, a non-transitory memory of server 802 and/or a non-transitory memory of client device 104 may store instructions that, when executed by processors of those devices, cause execution of the actions outlined within system 800.

In some embodiments, server 802 generates webpage 804 for display, at a client device with client ID 808. At action 820, server 802 stores user data and user actions 810 and client ID 808 in user profile 806. For example, a user has been browsing swimwear.com, has indicated a preference for swimwear, and has bought a women's suit. In this example, server 802 stores this information in a profile associated with the user's client device even though server 802 has not yet received user identification information for the client device. However, in some embodiments, user identification information 816, e.g., an email address, is provided to server 802 through form 812 in user-interactive response field 814. In some embodiments, at action 822, server 802 then updates user profile 806 to include user identification information 816 provided to server 802. For example, server 802 uses client ID 808 stored in a file on client device 104 to find user profile 806 that contains client ID 808 in a database on server 802. In this example, because user profile 806 contains client ID 808, server 802 updates user profile 806 to contain user identification information 816.

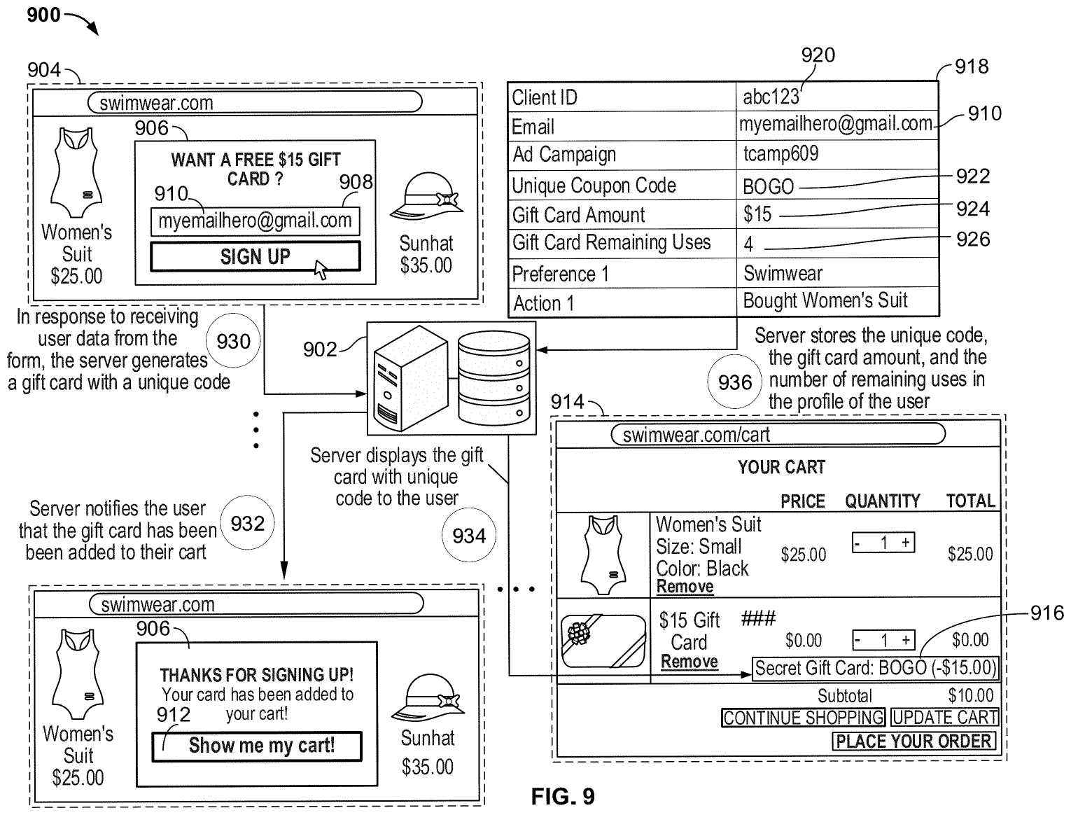

FIG. 9 is an illustrative example of a system for providing and storing a reward to a profile associated with a client device, in accordance with some embodiments of the present disclosure. System 900 includes server 902, webpage 904, form 906, user-interactive response field 908, user identification information 910, required user action 912, user shopping cart 914, gift card 916, user profile 918, client ID 920, dynamic coupon code 922, gift card amount 924, and gift card remaining uses 926. In some embodiments, server 902 is the same as server 102 in FIG. 1. In some embodiments, webpage 904 is the same as webpage 108 in FIG. 1. In some embodiments, form 906 is the same as form 110 in FIG. 1. In some embodiments, user-interactive response field 908 is the same as user-interactive response field 114. In some embodiments, user identification information 910 is the same as user identification information 116 in FIG. 1. In some embodiments, user profile 918 is the same as user profile 126 in FIG. 1. In some embodiments, client ID 920 is the same as client ID 128 in FIG. 1. In some embodiments, server 902 displays webpage 904 on a client device, such as client device 104 within FIG. 1. System 900 may include additional servers, devices and/or networks, such as any of the devices described above with respect to FIG. 5. For example, functionality of server 902 may be shared between several servers, providing a cloud computing solution.

In some examples, the actions outlined within system 900 are performed by server 902, or any other servers, devices and/or networks, such as any of the devices described above with respect to FIG. 5. For example, a non-transitory memory of server 902 and/or a non-transitory memory of client device 104 may store instructions that, when executed by processors of those devices, cause execution of the actions outlined within system 900.

In some embodiments, at action 930, server 902 generates dynamic coupon code 922 in response to receiving user identification information 910 inputted within user-interactive response field 908 through form 906 on webpage 904 on the client device associated with client ID 920. For example, server 902 receives an email address that a user has inputted on the form, and creates a coupon code, BOGO, in order for the user to get 15$ off of a purchase.

In some embodiments, at action 932, server 902 generates required user action 912 for display on form 906 on webpage 904 on the client device associated with client ID 920. For example, server 902 displays a user selectable option with text saying, “Show me my cart!” on the form. In this instance, in order to view the code, the user must select the button to show their cart. In another example, server 902 displays a user selectable option with text saying, “Add gift card to cart!” on the form. In this instance, the user must select the button to add the gift card to their cart.

In some embodiments, at action 934, in response to receiving user selection of required user action 912, server 902 generates for display the user shopping cart 914 and generates the gift card 916, containing dynamic coupon code 922 and gift card amount 924, for display on the webpage with user shopping cart 914 on the client device associated with client ID 920. For example, the browser on the client device navigates from webpage “swimwear.com” to webpage “swimwear.com/cart,” and, along with any other items that may be in the user's shopping cart, there is a dynamic coupon code, e.g., BOGO, and an indication of the gift card amount, e.g., $15, that the user will receive off of their purchase.

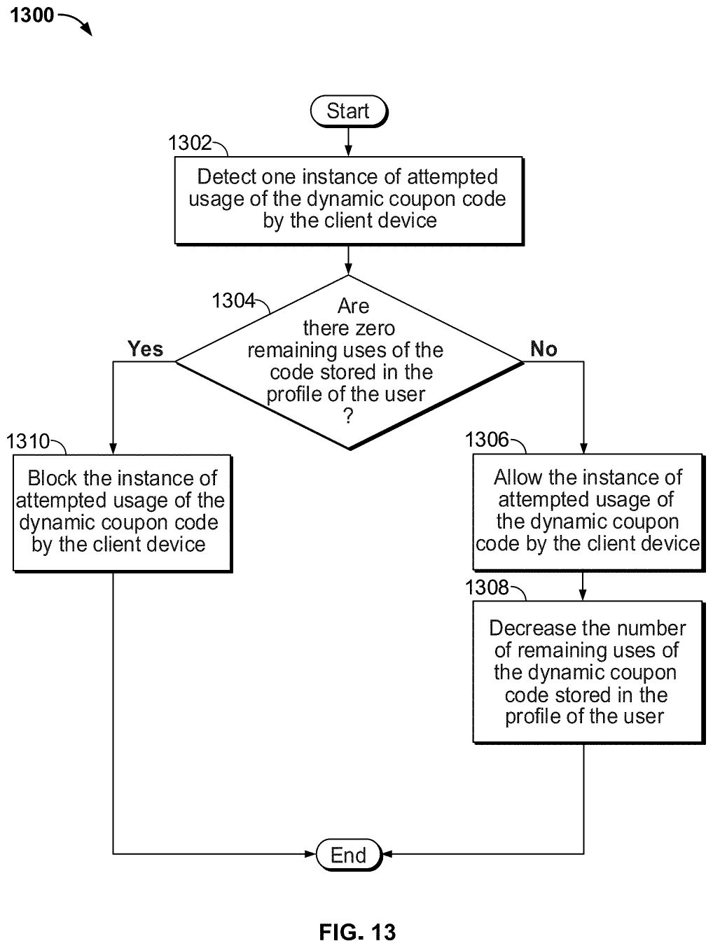

In some embodiments, at action 936, server 902 stores the dynamic coupon code 922, the gift card amount 924, and the gift card remaining uses 926, e.g., four uses, in user profile 918, which also contains the client ID 920 associated with the client device (e.g., client device 104) that server 902 is implementing system 900 on and the user identification information 910 that the user provided in order to receive the dynamic coupon code 922. In some embodiments, server 902 may keep track of gift card remaining uses 926, as described further below with respect to FIG. 13. In some embodiments, server 902, when adding a product to a user's shopping cart, may discount some or all of the purchase price of the product by, e.g., applying some or all of the gift card.

The aspects outlined in system 900 may be combined in any suitable combination, taken in part, or as a whole.

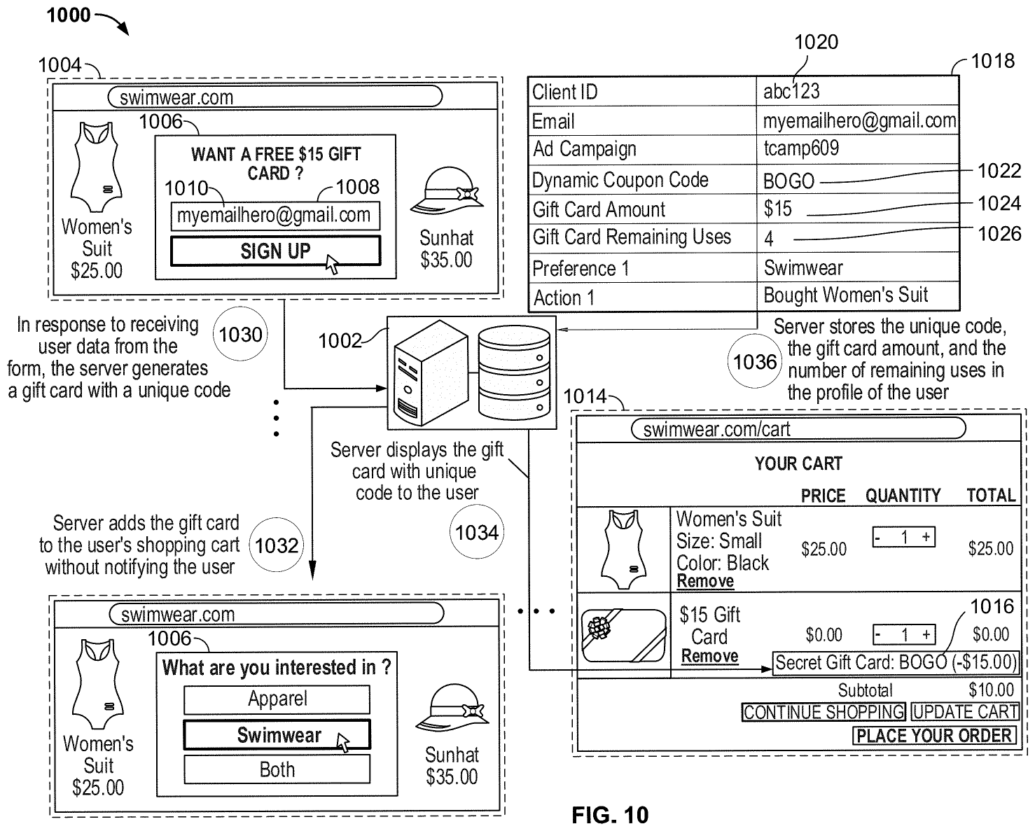

FIG. 10 is an illustrative example of a system for providing and storing a reward to a profile associated with a client device without requiring subsequent user action, in accordance with some embodiments of the present disclosure. System 1000 includes server 1002, webpage 1004, form 1006, user-interactive response field 1008, user identification information 1010, user shopping cart 1014, gift card 1016, user profile 1018, client ID 920, dynamic coupon code 1022, gift card amount 1024, and gift card remaining uses 1026. In some embodiments, server 1002 is the same as server 102 in FIG. 1. In some embodiments, webpage 1004 is the same as webpage 108 in FIG. 1. In some embodiments, form 1006 is the same as form 110 in FIG. 1. In some embodiments, user-interactive response field 1008 is the same as user-interactive response field 114. In some embodiments, user identification information 1010 is the same as user identification information 116 in FIG. 1. In some embodiments, user profile 1018 is the same as user profile 126 in FIG. 1. In some embodiments, client ID 1020 is the same as client ID 128 in FIG. 1. In some embodiments, server 1002 displays webpage 1004 on a client device, such as client device 104 within FIG. 1. System 1000 may include additional servers, devices and/or networks, such as any of the devices described above with respect to FIG. 5. For example, functionality of server 1002 may be shared between several servers, providing a cloud computing solution.

In some examples, the actions outlined within system 1000 are performed by server 1002, or any other servers, devices and/or networks, such as any of the devices described above with respect to FIG. 5. For example, a non-transitory memory of server 1002 and/or a non-transitory memory of client device 104 within FIG. 1 may store instructions that, when executed by processors of those devices, cause execution of the actions outlined within system 1000.

In some embodiments, at action 1030, server 1002 generates dynamic coupon code 1022 in response to receiving user identification information 1010 inputted within user-interactive response field 1008 through form 1006 on webpage 1004. For example, server 1002 receives an email address that a user has inputted on the form, and creates a coupon code, BOGO, in order for the user to get 15$ off of a purchase.

In some embodiments, at action 1032, in response to receiving user identification information 1010, server 1002 adds dynamic coupon code 1022 to the user's shopping cart 1014 without generating a required user action and continues to generate form 1006 for display on webpage 1004 on the client device associated with client ID 1020. For example, server 1002 may display a prompt and user selectable response fields without any further mention of the dynamic coupon code. In some embodiments, at action 1034, server 1002 generates for display the user shopping cart 1014 and generates the gift card 1016, containing dynamic coupon code 1022 and gift card amount 1024, for display on the webpage with user shopping cart 1014 on the client device associated with client ID 1020. For example, the browser on the client device navigates from webpage “swimwear.com” to webpage “swimwear.com/cart,” and along with any other items that may be in the user's shopping cart, there is a dynamic coupon code, e.g., BOGO, and an indication of the gift card amount, e.g., $15, that the user will receive off of their purchase.

In some embodiments, at action 1036, server 1002 stores the dynamic coupon code 1022, the gift card amount 1024, and the gift card remaining uses 1026, e.g., four uses, in user profile 1018. User profile 1018 also contains the client ID 1020 associated with the client device (e.g., client device 104 within FIG. 1) that server 1002 is implementing system 1000 on and the user identification information 1010 that the user provided in order to receive the dynamic coupon code 1022. In some embodiments, server 1002 may keep track of gift card remaining uses 1026, as described further below with respect to FIG. 13. In some embodiments, server 1002, when adding a product to a user's shopping cart, may discount some or all of the purchase price of the product by, e.g., applying some or all of the gift card. In some embodiments, server 1002 will discount some or all of the purchase price of the product without requiring further user action. In some embodiments, server 1002 will discount some or all of the purchase price of the product without notifying the user until the user is checking out and completing their purchase.

The aspects outlined in system 1000 may be combined in any suitable combination, taken in part, or as a whole.

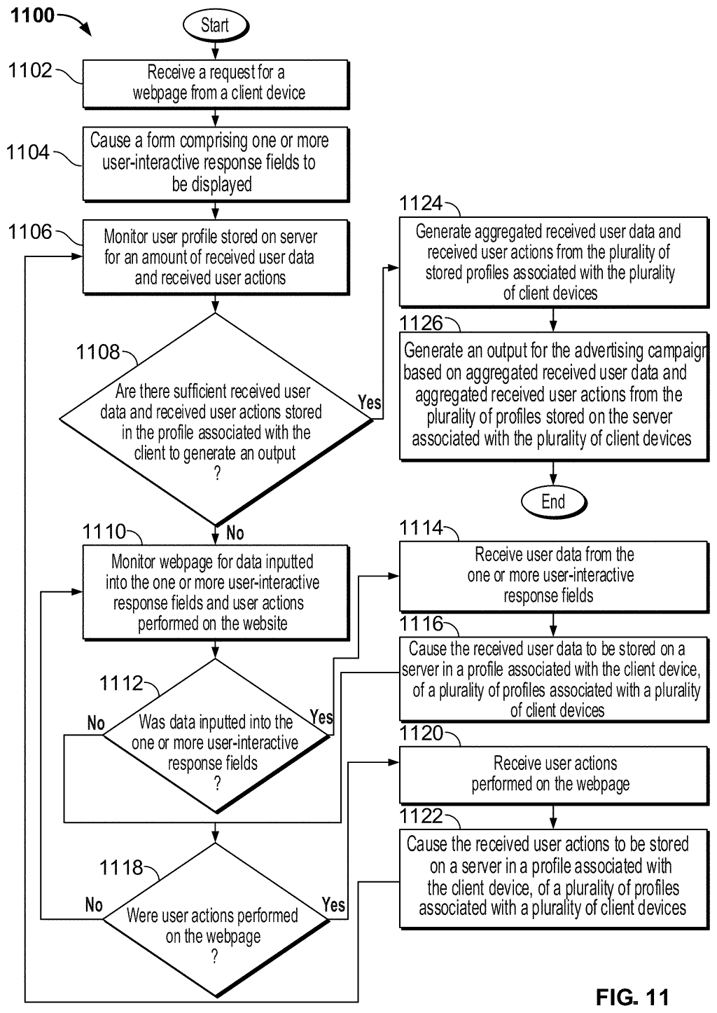

FIG. 11 shows a flowchart of an illustrative process for measuring the strength of a user engagement strategy including zero-party data over a network. In some examples, the individual steps of process 1100 may be implemented by server 102 within FIG. 1, or any other servers, devices and/or networks, such as any of the devices described above with respect to FIGS. 5 and 6. For example, the individual steps of process 1100 may be encoded onto a non-transitory storage medium (e.g., storage 608) as a set of instructions to be decoded and executed by processing circuitry (e.g., processing circuitry 606). Processing circuitry may, in turn, provide instructions to other sub-circuits contained within control circuitry 604.

In some embodiments, at 1102, server 102 receives via input/output circuitry, for example, I/O path 610, a request for a webpage from a client device (e.g., client device 104). Server 102 may transmit the received request via any suitable input (e.g., textual or voice input within a browser search bar indicating an interest in the webpage) over a network (e.g., network 504).

In some embodiments, at 1104, after receiving the request for a webpage, server 102, through control circuitry 604, causes a form (e.g., form 110) comprising one or more user-interactive response fields (e.g., user-interactive response fields 120) to be displayed on the webpage on the client device (e.g., client device 104).

In some embodiments, at 1106, after control circuitry 604 causes the form to be displayed, control circuitry 604 begins to monitor the user profile (e.g., user profile 126 within FIG. 1) on server 102 for an amount of received user data and received user actions. At 1108, if control circuitry 604 detects that the amount of received user data and received user actions is above certain predetermined thresholds, e.g., thresholds set by the administrative device 106 within FIG. 1, for example, two data points of user data and one user action, then process 1100 proceeds to 1124. If control circuitry 604 detects that the amount of received user data and received user actions are below the predetermined thresholds, process 1100 proceeds to 1110.

In some embodiments, at 1110, after detecting that the amount of received user data and received user actions are below the predetermined thresholds, control circuitry 604 begins to monitor the webpage for data inputted into the one or more user-interactive response fields (e.g., user-interactive response fields 114 and 120 within FIG. 1). At 1112, if control circuitry 604 detects that a user inputted data into the one or more user-interactive response fields, for example, there was a user input of an email address and a user selection of a preference for swimwear on the form, process 1100 proceeds to 1114. At 1112, if control circuitry 604 detects that the user did not input any data into the one or more user-interactive response fields, process 1100 proceeds to 1118.

In some embodiments, at 1114, after detecting that the user inputted data into the one or more user-interactive response fields, control circuitry 604 receives the user data that the user inputted into the user-interactive response fields. Client device 104 may transmit user data from client device 104 to server 102 via a network, such as network 504.

In some embodiments, at 1116, after control circuitry 604 receives the user data, storage circuitry, for example, storage circuitry 608, causes the received user data to be stored on server 102 in user profile 126, which is one user profile of a plurality of profiles associated with a plurality of clients. For example, storage circuitry stores the user's email address and their user selection of a preference for swimwear in a profile with an identifier for the client device 104.

In some embodiments, at 1118, if control circuitry 604 detects that a user performed user actions on the webpage, for example, that a user has purchased a swimsuit, or added a pair of flip-flops to their cart, process 1100 proceeds to 1120. If control circuitry 604 detects that the user has not performed any user actions on the webpage, process 1100 returns to 1110 and continues monitoring the webpage for data inputted into the one or more user-interactive response fields and user actions performed on the webpage.

In some embodiments, at 1120, after detecting that the user has performed user actions on the webpage, control circuitry 604 receives the user actions. Client device 104 may transmit user actions to server 102 via a network, such as network 504.

In some embodiments, at 1122, after control circuitry 604 receives the user actions, storage circuitry, for example, storage circuitry 608, causes the received user actions to be stored on server 102 in user profile 126, which is one user profile of a plurality of profiles associated with a plurality of clients. For example, storage circuitry stores the user's purchase of a swimsuit in a profile with an identifier for the client device 104. In some embodiments, in response to causing the received user actions to be stored on the server, process 1100 returns to 1106, and control circuitry 604 continues to monitor the user profile stored on the server for an amount of received user data and received user actions. At 1108, if control circuitry 604 detects that the amount of received user data and received user actions are above certain predetermined thresholds, e.g., thresholds set by the administrative device 106 within FIG. 1, for example, two data points of user data and one user action, then process 1100 proceeds to 1124.

In some embodiments, at 1124, after control circuitry 604 detects that there are sufficient received user data and received user actions stored in the profile associated with the client to generate a score. Control circuitry 604 may then generate aggregated received user data and received user actions from a plurality of stored profiles associated with the plurality of client devices inputting user data and performing user actions on webpages. For example, control circuitry 604 groups the received user data and user actions corresponding to each advertising campaign by similarities, e.g., ten users indicated a preference for swimwear and bought a swimsuit, five users indicated a preference for apparel and bought flip-flops.

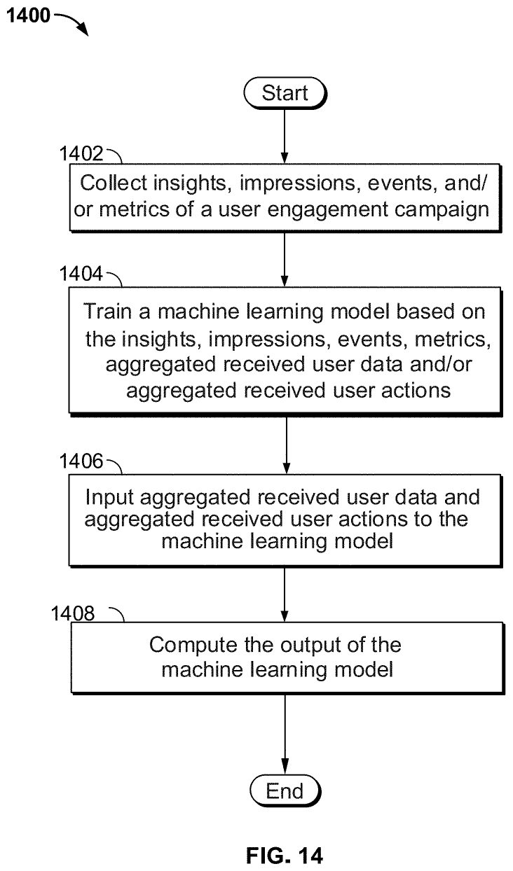

In some embodiments, at 1126, after control circuitry 604 generates aggregated received user data and received user actions, control circuitry 604 generates an output corresponding to user engagement. In some instances, the output is a score for the advertising campaign associated with the form, e.g., the advertising campaign associated with advertising campaign ID 130 within FIG. 1. In some instances, the score is a percentage out of 100%, e.g., 48% that indicates the strength of the advertising campaign compared to other advertising campaigns that the user of administrative device 106 is tracking. In some embodiments, server 102 generates the output using a trained machine learning model, as described further below with reference to FIG. 14.

FIG. 12 shows a flowchart of an illustrative process for detecting and creating user profiles associated with client devices. In some examples, the individual steps of process 1200 may be implemented by server 102 on client device 104 within FIG. 1, or any other servers, devices and/or networks, such as any of the devices described above with respect to FIGS. 5 and 6. For example, the individual steps of process 1200 may be encoded onto a non-transitory storage medium (e.g., storage 608) as a set of instructions to be decoded and executed by processing circuitry (e.g., processing circuitry 606). Processing circuitry may, in turn, provide instructions to other sub-circuits contained within control circuitry 604.

In some embodiments, at 1202, server 102 receives via input/output circuitry, for example, I/O path 610, a request for a webpage from a client device (e.g., client device 104). Client device 104 may transmit the received request via any suitable input (e.g., textual or voice input within a browser search bar indicating an interest in the webpage) over a network (e.g., network 504).

In some embodiments, at 1204, after receiving the request for a webpage, server 102, through control circuitry, for example, control circuitry 604, detects whether the webpage contains a file with a unique identifier, for example, a file in the example data format of system 400 within FIG. 4. If the server detects that the webpage contains a file with a unique identifier, process 1200 proceeds to 1206. If the server detects that the webpage does not contain a file with a unique identifier, process 1200 proceeds to 1208.

In some embodiments, at 1206, after detecting that the webpage does contain a file with a unique identifier, control circuitry 604 identifies the user profile (e.g., user profile 126 of FIG. 1) stored on the server that has the unique identifier stored as its client ID (e.g., client ID 128 of FIG. 1) as the profile associated with the client device that requested the webpage from the server.

In some embodiments, at 1208, after determining that the webpage does not contain a file with a unique identifier, control circuitry 604 generates a file on the webpage with a unique identifier, for example, by embedding a cookie in the webpage with a client ID of an auto-generated alphanumerical string, e.g., “abc123.”

In some embodiments, at 1210, after generating a file on the webpage with the unique identifier, control circuitry 604 creates a user profile containing the unique identifier as the client ID for the client device on the server. For example, control circuitry 604 creates a user profile with the client ID “abc123” corresponding to the unique identifier of “abc123” on the webpage.

In some embodiments, at 1212, after creating the user profile, storage circuitry, for example, storage circuitry 608, causes the user profile to be stored on the server. For example, the storage circuitry 608 stores user profile with the client ID “abc123” on server 102.

FIG. 13 shows a flowchart of an illustrative process for monitoring remaining uses of a code for a user profile. In some examples, the individual steps of process 1300 may be implemented by server 102 within FIG. 1, or any other servers, devices and/or networks, such as any of the devices described above with respect to FIGS. 5 and 6. For example, the individual steps of process 1300 may be encoded onto a non-transitory storage medium (e.g., storage 608) as a set of instructions to be decoded and executed by processing circuitry (e.g., processing circuitry 606). Processing circuitry may, in turn, provide instructions to other sub-circuits contained within control circuitry 604.

In some embodiments, at 1302, server 102, through control circuitry, for example, control circuitry 604, detects an instance of attempted usage of a unique coupon code, e.g., dynamic coupon code 922 in FIG. 9. For example, control circuitry detects that a user has attempted to make a purchase of a swimsuit using the coupon code BOGO for $15 off of their purchase.

In some embodiments, at 1304, control circuitry 604 determines whether there are zero remaining uses of the code stored in the profile of the server. For example, control circuitry 604 detects the number of remaining uses in the user profile stored on the server, for example, the gift card remaining uses 926 in user profile 918 within FIG. 9. If there are zero remaining uses of the code, process 1300 proceeds to 1310. If there are not zero remaining uses of the code, process 1300 proceeds to 1306.

In some embodiments, at 1310, control circuitry 604 blocks the instance of attempted usage of the coupon code by the client, for example, by not allowing the attempted purchase to go through while using the coupon code and notifying the user that there are no remaining uses of the coupon code.

In some embodiments, at 1306, control circuitry 604 allows the instance of attempted usage of the coupon code by the client, for example, by completing the attempted purchase using the coupon code. In some embodiments, in response to allowing the instance of the attempted usage of the coupon code, process 1300 proceeds to 1308.

In some embodiments, at 1308, control circuitry 604 decreases the number of gift card remaining uses in the user profile stored on the server, e.g., the gift card remaining uses 926 in user profile 918 within FIG. 9, for example, by subtracting one from the count of remaining uses.

FIG. 14 shows a flowchart of an illustrative process for training a machine learning model based on insights, impressions, events, and/or metrics of a user engagement campaign, user data, and user actions. In some examples, the individual steps of process 1400 may be implemented by server 102 within FIG. 1, or any other servers, devices and/or networks, such as any of the devices described above with respect to FIGS. 5 and 6. For example, the individual steps of process 1400 may be encoded onto a non-transitory storage medium (e.g., storage 608) as a set of instructions to be decoded and executed by processing circuitry (e.g., processing circuitry 606). Processing circuitry may, in turn, provide instructions to other sub-circuits contained within control circuitry 604.

In some embodiments, process 1400 is an embodiment of 1126 in process 1100 within FIG. 11, where control circuitry 604 generates an output corresponding to user engagement.

In some embodiments, at 1402, control circuitry 604 collects insights, impressions, events, and/or metrics of a user engagement campaign, for example, from remote servers over a network, as described in system 300 within FIG. 3. After collecting the insights, impressions, events, and/or metrics, process 1400 proceeds to 1404.

In some embodiments, at 1404, control circuitry 604 trains a machine learning model based on the insights, impressions, events, and/or metrics of a user engagement campaign. For example, control circuitry 604 trains the machine learning model by inputting at least one of the insights, impressions, events, and/or metrics and computing the output for the campaign. Control circuitry 604 may update weights between nodes in the model when the output does not correspond to an expected output for the inputted insights, impressions, events, and/or metrics. After training the machine learning model, process 1400 proceeds to 1406.

In some embodiments, at 1406, control circuitry 604 inputs aggregated received user data (e.g., form responses indicating user preferences, such as preferences for swimwear or apparel) and aggregated received user actions (e.g., purchases or additions to a shopping cart) into the machine learning model. For example, control circuitry 604 may generate a vector comprising the aggregated received user data and aggregated received user actions and may apply each element of the vector to a distinct input node (e.g., input nodes 204/224). After inputting aggregated received user data and aggregated received user actions into the machine learning model, process 1400 proceeds to 1408.

In some embodiments, at 1408, control circuitry 604 computes the output of the machine learning model, for example, output 132 from FIG. 1. As described above with respect to FIG. 2, control circuitry 604 may compute values for output node(s) 212/232 based on values applied to input nodes 204/224. In some instances, output values 212/232 indicate a performance of a user engagement campaign. For example, when a campaign has high user engagement, control circuitry 604 may compute a high value for output node(s) 212/232. When a campaign has low user engagement, control circuitry 604 may compute a low value for output node(s) 212/232. In some embodiments, control circuitry 604 scales the score so that the score of a first user engagement campaign is relative the score of a second user engagement campaign. In some embodiments, control circuitry 604 may provide a recommendation based on the computed score. For example, control circuitry 604 may recommend keeping a first user engagement campaign active when a score for the first user engagement campaign is above a certain threshold and may recommend ending a second user engagement campaign when a score for the second user engagement campaign is below a certain threshold.

The foregoing is merely illustrative of the principles of this disclosure and its various embodiments. The processes described above are intended to be illustrative and not limiting. Various modifications may be made by those skilled in the art without departing from the scope of this disclosure, and those skilled in the art would appreciate that the actions of the processes discussed herein may be omitted, modified, combined, and/or rearranged, and any additional actions may be performed without departing from the scope of the disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method for measuring the strength of a user engagement strategy including zero-party data over a network comprising:
receiving a request for a webpage from a client device;
in response to receiving the request for the webpage, causing to be displayed a form, wherein the form comprises a user-interactive response field;
receiving user data via the user-interactive response field;
receiving a user action performed on the webpage;
causing to be stored in a profile associated with the client device, on a first server, the received user data and the received user action, wherein the profile associated with the client device is one of a plurality of stored profiles associated with a plurality of client devices;
generating aggregated received user data and aggregated received user actions from the plurality of stored profiles associated with the plurality of client devices; and
generating an output corresponding to user engagement, based on the aggregated received user data and the aggregated received user actions.

2. The method of claim 1, wherein generating the output further comprises:
training a machine learning model based on at least one of aggregated received user data, aggregated received user actions, insights, impressions, events, and metrics; and
computing the output using the trained machine learning model by inputting the aggregated received user data and the aggregated received user actions to input nodes of the trained machine learning model.

3. The method of claim 2, further comprising receiving at least one of the insights, impressions, events, and metrics from a second server, remote from the first server.

4. The method of claim 1, further comprising:
in response to receiving the request for the webpage, determining whether a file with a unique identifier for the client device is stored on the client device;
in response to detecting that the file with the unique identifier for the client device is stored on the client device:
identifying the profile associated with the client device, stored on the server, based on the unique identifier;
in response to detecting that the file with the unique identifier for the client device is not stored on the client device:
generating a unique number for the client device;
generating a file comprising the generated unique identifier for the client device;
storing the file comprising the generated unique identifier on the client device;
creating the profile associated with the client device, wherein the profile comprises the unique identifier; and
storing the profile on the server.

5. The method of claim 1, wherein the form comprises a multi-step form that uses responses to prompts to generate or select subsequent prompts based on a progression of a logic mapping.

6. The method of claim 1, wherein the causing to be stored the received user data further comprises updating the profile associated with the client device to include identifying information inputted by the user.

7. The method of claim 1, further comprising:
in response to receiving the user data from the user-interactive response field, providing a reward to the profile associated with the client device.

8. The method of claim 7, wherein the providing the reward comprises:
generating a code comprising a unique sequence of characters and a number of remaining uses;
transmitting the code to a remote server;
storing, in the profile associated with the client device, the unique sequence of characters and the number of remaining uses; and
causing to be displayed on the client device, the code.

9. The method of claim 7, wherein providing the reward comprises adding the code to a shopping cart for the user without requiring a subsequent user action.

10. The method of claim 8, further comprising:
detecting an attempted use of the code;
determining the number of remaining uses based on the profile associated with the client device;
in response to detecting that the number of remaining uses of the code is zero:
blocking the instance of attempted use of the code;
in response to detecting that the number of remaining uses of the code is not zero:
allowing usage of the code; and
decreasing the number of remaining uses stored in the profile associated with the client device.

11. A system for measuring the strength of a user engagement strategy including zero-party data over a network comprising:
control circuitry configured to:
receive a request for a webpage from a client device;
in response to receiving the request for the webpage, cause to be displayed a form, wherein the form comprises a user-interactive response field;
receive user data via the user-interactive response field;
receive a user action performed on the webpage;
storage circuitry configured to:
cause to be stored in a profile associated with the client device, on a first server, the received user data and the received user action, wherein the profile associated with the client device is one of a plurality of stored profiles associated with a plurality of client devices;
wherein the control circuitry is further configured to:
generate aggregated received user data and aggregated received user actions from the plurality of stored profiles associated with the plurality of client devices; and
generate an output corresponding to user engagement, based on the aggregated received user data and the aggregated received user actions.

12. The system of claim 11, wherein the control circuitry is further configured to generate the output by:
training a machine learning model based on at least one of aggregated received user data, aggregated received user actions, insights, impressions, events, and metrics; and
computing the output using the trained machine learning model by inputting the aggregated received user data and the aggregated received user actions to input nodes of the trained machine learning model.

13. The system of claim 12, wherein the control circuitry is further configured to:
receive at least one of the insights, impressions, events, and metrics from a second server, remote from the first server.

14. The system of claim 11, wherein the control circuitry is further configured to:
in response to receiving the request for the webpage, determine whether a file with a unique identifier for the client device is stored on the client device;
in response to detecting that the file with the unique identifier for the client device is stored on the client device:
identify the profile associated with the client device, stored on the server, based on the unique identifier;
in response to detecting that the file with the unique identifier for the client device is not stored on the client device:
generate a unique number for the client device;
generate a file comprising the generated unique identifier for the client device;
store the file comprising the generated unique identifier on the client device;
create the profile associated with the client device, wherein the profile comprises the unique identifier; and
store the profile on the server.

15. The system of claim 11, wherein the form comprises a multi-step form that uses responses to prompts to generate or select subsequent prompts based on a progression of a logic mapping.

16. The system of claim 11, wherein the storage circuitry is further configured, when causing to be stored the received user data, to update the profile associated with the client device to include identifying information inputted by the user.

17. The system of claim 11, wherein the control circuitry is further configured, in response to receiving the user data from the user-interactive response field, to provide a reward to the profile associated with the client device.

18. The system of claim 17, wherein the control circuitry is further configured, when providing the reward, to:
generate a code comprising a unique sequence of characters and a number of remaining uses;
transmit the code to a remote server;
store, in the profile associated with the client device, the unique sequence of characters and the number of remaining uses; and
cause to be displayed on the client device, the code.

19. The system of claim 17, wherein the control circuitry is further configured, when providing the reward, to add the code to a shopping cart for the user without requiring a subsequent user action.

20. The system of claim 18, wherein the control circuitry is further configured to:
detect an attempted use of the code;
determine the number of remaining uses based on the profile associated with the client device;
in response to detecting that the number of remaining uses of the code is zero:
block the instance of attempted use of the code;
in response to detecting that the number of remaining uses of the code is not zero:
allow usage of the code; and
decrease the number of remaining uses stored in the profile associated with the client device.
